(19) United States
(12) Patent Application Publication
(10) Pub. No.: US 2024/0084139 A1
(43) Pub. Date: Mar. 14, 2024

(54) COMPOSITION INCLUDING POLYSILOXANES, HYDROSILYLATION CATALYST, AND PHOSPHOROUS-CONTAINING FLAME RETARDANT ENCAPSULATED IN CROSSLINKED, NITROGEN-CONTAINING POLYMER AND RELATED ARTICLE

(71) Applicant: 3M INNOVATIVE PROPERTIES COMPANY, St. Paul, MN (US)

(72) Inventors: Shaomin Sun, Shanghai (CN); Lianzhou Chen, Woodbury, MN (US); Brandon A. Bartling, Woodbury, MN (US); QiongJuan Duan, Shanghai (CN); Enzhong Zhang, Shanghai (CN); Jeffrey E. Kapp, Cheltenham (GB); Xiao Gao, Woodbury, MN (US)

(21) Appl. No.: 18/269,276

(22) PCT Filed: Dec. 23, 2020
(86) PCT No.: PCT/CN2020/138564

§ 371 Date: Jun. 22, 2023

(51) Int. Cl. C08L 83/04; H01M 10/658; H01M 50/213

(52) U.S. Cl. CPC C08L 83/04; H01M 10/658; H01M 50/213; C08L 2205/025

(57) ABSTRACT

The composition includes a vinyl-substituted polysiloxane having at least two vinyl groups, a hydrosilylation catalyst, a hydrosilyl-substituted polysiloxane having at least two silicon-hydride groups, and a phosphorous-containing flame retardant encapsulated in a crosslinked, nitrogen-containing polymer. The composition may be a two-part composition including a first part and a second part. The first part includes a vinyl-substituted polysiloxane, a hydrosilylation catalyst, and a phosphorous-containing flame retardant encapsulated in a crosslinked, nitrogen-containing polymer. The second part includes a second vinyl-substituted polysiloxane and a hydrosilyl-substituted polysiloxane. A battery module including a plurality of battery cells and the composition at least partially encasing the plurality of battery cells is also disclosed.

### BACKGROUND

Metal-curable silicone polymers can be used as a one-part silicone system or a two-part silicone system. One-part and two-part metal (platinum) curable silicone polymers are commercially available. In a two-part silicone system, also referred to as liquid silicone rubber (LSR), a vinyl-functional silicone polymer (typically identified as part A) may be vulcanized in presence of a silicone having Si-H groups (part B). Part A typically contains the platinum catalyst. Two-part platinum curable silicone systems are commercially available, for example, under the trade designation ELASTOSIL R 533/60 A/B and ELASTOSIL LR 7665 from Wacker Chemie, AG and SILASTIC 9252/900P from Dow Corning.

Silicone syntactic foams useful for thermal management in battery packs are disclosed in U.S. Pat. No. 10,501,597 (O'Neil et al.) and U.S. Pat. Appl. Pub. No. 2018/0223069 (O'Neil et al.).

### SUMMARY OF THE DISCLOSURE

The present disclosure provides a composition that includes a vinyl-substituted polysiloxane, a hydrosilyl-substituted polysiloxane, a hydrosilylation catalyst, and an encapsulated phosphorous-containing flame retardant. The phosphorous-containing flame retardant is encapsulated in a crosslinked, nitrogen-containing polymer. Despite the tendency of phosphorous- and nitrogen-containing compounds to inhibit hydrosilylation catalysts, the compositions of the present disclosure are surprisingly curable and exhibit a stable cure time after storage. The composition of the present disclosure is useful, for example, as an encapsulation or potting material for battery cells and as a molded pad material for a battery module.

In one aspect, the present disclosure provides a composition that includes a vinyl-substituted polysiloxane having at least two vinyl groups, a hydrosilyl-substituted polysiloxane having at least two silicon-hydride groups, a hydrosilylation catalyst, and a phosphorous-containing flame retardant encapsulated in a crosslinked, nitrogen-containing polymer.

In another aspect, the present disclosure provides a two-part composition including a first part and a second part. The first part includes a vinyl-substituted polysiloxane having at least two vinyl groups, a hydrosilylation catalyst, and a phosphorous-containing flame retardant encapsulated in a crosslinked, nitrogen-containing polymer. The second part includes a second vinyl-substituted polysiloxane and a hydrosilyl-substituted polysiloxane, in which the second vinyl-substituted polysiloxane can be the same as in the first part.

In another aspect, the present disclosure further provides a cured product of the composition. The cured product can be prepared, for example, by combining the first part and the second part and allowing the resulting curable composition to cure at room temperature.

The present disclosure further provides a battery module including a plurality of battery cells and the composition disclosed herein at least partially encasing the plurality of battery cells. The battery cells are typically electrically connected to one another. The composition may be cured to provide a cured product of the composition at least partially encasing the plurality of battery cells.

The present disclosure further provides a vehicle that includes the battery module.

### BRIEF DESCRIPTION OF THE FIGURES

The drawings illustrate generally, by way of example, but not by way of limitation, various embodiments discussed in the present disclosure.

FIG. 1 is a top view of battery cells in a battery module with an embodiment of the composition of the present disclosure at least partially encasing battery cells within the module.

FIG. 2 is a side view of battery cells in a battery module with an embodiment of the composition of the present disclosure at least partially covering battery cells within the module.

FIG. 3 is a side view of an embodiment of the battery module of the present disclosure with a layer of silicone rubber foam at least partially covering battery cells within the module.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 30 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

In this application, terms such as “a,” “an,” and “the” are not intended to refer to only a singular entity but include the general class of which a specific example may be used for illustration. The terms “a,” “an,” and “the” are used interchangeably with the phrases “at least one” and “one or more.” The phrases “at least one of” and “comprises at least one of” followed by a list refers to any one of the items in the list and any combination of two or more items in the list.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The “composition” as disclosed herein in any of its embodiments can be a one-part composition that includes the vinyl-substituted polysiloxane, the hydrosilylation catalyst, the hydrosilyl-substituted polysiloxane, and the phosphorous-containing flame retardant encapsulated in a nitrogen-containing polymer and/or it can result from combining the first part and the second part of the two-part composition disclosed herein in any of its embodiments. Embodiments of the composition that refer to a first part and a second part refer to a two-part composition.

The term “phosphorous-containing flame retardant” as used herein means that the flame retardant includes at least one phosphorous atom. Thus, this element may also be called a “phosphorous atom-containing flame retardant”.

The term “nitrogen-containing polymer” as used herein means that the polymer includes at least one nitrogen atom. Thus, this element may also be called a “nitrogen atom-containing polymer”.

The term “crosslinked” refers to polymer chains joined together by covalent chemical bonds, usually via crosslinking molecules or groups, to form a network polymer. A crosslinked polymer is generally characterized by insolubility but may be swellable in the presence of an appropriate solvent.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃),₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

The term “room temperature” as used herein refers to a temperature of about 15° C. to 40° C.

The term “ceramic” refers to glasses, crystalline ceramics, glass-ceramics, and combinations thereof.

Platinum-catalyzed addition cure silicone chemistry can be inhibited by certain chemicals believed to poison the hydrosilylation catalyst. This can result in non-cured regions in an otherwise cured composition, or the entire composition may fail to cure. Techsil Ltd., Warwickshire, UK, includes in their website, “A Technical Guide to Cure Inhibition.” There, it is advised to avoid substances including amines, amide-cured epoxy adhesives, acrylonitrile butadiene rubber, nitrile rubber, phosphate compounds, phosphite compounds, and phosphorous. In this and other technical literature, nitrogen- or phosphorous-containing compounds are discouraged in compositions including platinum-catalyzed addition cure silicones.

In the fast-growing electric vehicle market, there is growing demand for battery pack sealing and potting materials. Generally, sealing and potting materials having some flame resistance are useful. Many phosphorous-containing compounds are effective flame retardants. It is reported that phosphorous-containing compounds can prevent thermal runaway in the electrolyte of lithium ion batteries by promoting charring and interrupting the combustion process (see, e.g., Huang, et al., Journal of Power Sources, 338 (2017) 82-90). Such properties made phosphorous-containing compounds desirable to the present inventors as flame retardants for potting and sealing compositions, but their tendency to inhibit hydrosilylation catalysts limits the compositions in which they are useful.

We have surprisingly found that phosphorous-containing flame retardants encapsulated in crosslinked, nitrogen-containing polymers do not inhibit curing in addition cured silicone compositions. Moreover, since some nitrogen-containing polymers are considered useful flame retardants on their own, the phosphorous-containing flame retardant encapsulated in a crosslinked, nitrogen-containing polymer provides very useful flame retardancy. Also advantageously, the crosslinked, nitrogen-containing polymer can be useful for reducing the moisture absorption phosphorous-containing flame retardant, which may be detrimental to the electrical performance of the composition, and for reducing contact between flame retardant particles, which may beneficially reduce the thermal conductivity of the composition.

The composition of the present disclosure and at least the first part of the two-part composition of the present disclosure include a polymer-encapsulated flame retardant. The polymer is a crosslinked, nitrogen-containing polymer, and the flame retardant is a phosphorous-containing flame retardant. In some embodiments, the phosphorous-containing flame retardant comprises at least one of a phosphate, a polyphosphate, a phosphonate, a phosphinate, a phosphazene, a phosphine, or a phosphine oxide. Useful phosphorous-containing flame retardants include red phosphorus; tri(2-chloroethyl)phosphate (TCEP); tri(2-chloropropyl)phosphate (TCPP); tri(2,3-dichloropropyl)phosphate (TDCP); mono-ammonium phosphate; diammonium phosphate; triphenylphosphate; those obtained from Clariant Corporation, Charlotte, N.C., under the trade designations “EXOLIT OP” in various grades and “EXOLIT RP”; ammoniumpolyphosphate (APP); melamine phosphate (MP); tri(2,3-dibromopropyl)phosphate; tetrakis(hydroxymethyl)phosphoniumchloride (THPC); cyclic phosphate derivatives; phosphorus-containing polyol polyether; tri(chloroethyl)phosphate; zinc phosphate; trimethylphosphonate; trimethyl phosphate; guanidine phosphate; ammonium dihydrogen phosphate; diammonium hydrogen phosphate; tribenzyl phosphate; melamine polyphosphate (salt) (MPP); triphenylphosphine (TPP); triphenylphosphine (TPPO); tri(beta-chloroethyl)phosphate (TCEP); dimethyl methylphosphate (DMMP); and tri(bromophenyl)phosphate (PB-460). In some embodiments, the phosphorous-containing flame retardant is a phosphate or a polyphosphate. In some embodiments, the phosphorous-containing flame retardant is an inorganic phosphate or a polyphosphate. Suitable crosslinked, nitrogen-containing polymers include polyurethanes, urea-formaldehyde resin, melamine-formaldehyde resin, melamine-urea-formaldehyde resin, and polyimides. In some embodiments, the crosslinked, nitrogen-containing polymer is a urea-formaldehyde resin, a melamine-formaldehyde resin, or a melamine-urea-formaldehyde resin. In some embodiments, the crosslinked, nitrogen-containing polymer is a melamine-formaldehyde resin.

Phosphorous compounds can be encapsulated in nitrogen-containing polymers, for example, by oil-in-water emulsion polymerization methods. For example, a phosphorous compound can be melted or dissolved in solvent and added to a solution of a monomer in water and emulsified. Additional monomer may be added, and the polymerization may be carried out with heating and stirring, if desired. Encapsulation of phosphorous compounds can also be carried out using a variety of physical means such as fluid bed coating, spray coating, pan coating, air-suspension coating, and microgranulation. Some phosphorous-containing flame retardants encapsulated in a crosslinked, nitrogen-containing polymer are commercially available, for example, ammonium polyphosphate micro-encapsulated with melamine resin is available under the designations “EXOLIT AP 462” from Clariant Corporation, Charlotte, N.C., and “FR CROS 487” from Budenheim, Mansfield, Ohio.

The phosphorous-containing flame retardants encapsulated in crosslinked, nitrogen-containing polymers can be present in the composition or in at least one of the first part or the second part of the two-part composition in a range of from about 2 wt % to about 50 wt %, about 5 wt % to about 40 wt %, or less than, equal to, or greater than about 2 wt %, 2.5, 3, 3.5, 4, 4.5, 5, 5.5, 6, 6.5, 7, 7.5, 8, 8.5, 9, 9.5, 10, 10.5, 11, 11.5, 10 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, or about 50 wt %, based on the total weight of the composition or at least one of the first part or the second part of the two-part composition.

The phosphorous-containing flame retardants encapsulated in crosslinked, nitrogen-containing polymers can render the composition of the present disclosure substantially flame retardant. The flame retardancy of the composition of the present disclosure is measured on the cured composition using the method described in the Examples, below. In some embodiments, the cured composition meets a UL 94 standard of at least V2, V1, or V0.

Furthermore, as shown in a comparison of Comparative Example 1 and Example 10 in the Examples below, an unencapsulated phosphorous-containing flame retardant compromised the cure time of a composition including a platinum catalyst and a vinyl-substituted polysiloxane while a phosphorous-containing flame retardant encapsulated in a crosslinked, nitrogen-containing polymer did not. Curing of Comparative Example 1 and Example 10 was evaluated by the time needed to be able to peel the composition from a substrate after mixing the first and second parts and dispensing the composition on the substrate.

Curing was also evaluated by the time needed for the composition to become tack-free after mixing the first and second parts and dispensing the composition on a substrate. A tack-free cured product is desirable for preventing debris such as dirt or other particulate materials from sticking to the cured product. A comparison of Comparative Example 1 and Example 10 clearly shows that cure time is more than twice as long for Comparative Example 1, which can be an indication that the catalyst is poisoned by phosphate compounds in the flame retardant additives. For Example 10, which included a phosphorous-containing flame retardant encapsulated in a crosslinked, nitrogen-containing polymer, the cure time was much shorter, suggesting that the catalyst is not poisoned by the phosphorous-containing flame retardant encapsulated in a crosslinked, nitrogen-containing polymer. Catalyst poisoning can be even more problematic when a composition including the catalyst and unencapsulated phosphorous-containing flame retardant is stored for any length of time.

The composition of the present disclosure includes a vinyl-substituted polysiloxane having at least two vinyl groups. The first part of the two-part composition of the present disclosure includes a vinyl-substituted polysiloxane having at least two vinyl groups. The vinyl-substituted polysiloxane can comprise one or more vinyl polysiloxane homopolymers, vinyl polysiloxane copolymers, or combinations thereof. The vinyl-substituted polysiloxane can include a blend of vinyl-substituted polysiloxanes that differ in structure, molecular weight, mole percent of repeating units, or vinyl content.

In some embodiments, the composition of the present disclosure includes a first part and a second part. The first part and the second part include a first vinyl-substituted polysiloxane and a second vinyl-substituted polysiloxane, respectively. The first vinyl-substituted polysiloxane and a second vinyl-substituted polysiloxane can be the same or different from each other, and each can include one or more vinyl polysiloxanes. In some embodiments, the first and second vinyl-substituted polysiloxanes are identical in structure, molecular weight, mole percent of repeating units, and vinyl content.

The vinyl-substituted polysiloxane can be present in the composition and at least one of the first part or the second part of the two-part composition in any suitable weight percentage (wt %). For example, the vinyl-substituted polysiloxane can be present in a range of from about 20 wt % to about 90 wt %, about 29 wt % to about 80 wt %, about 34 wt % to about 46 wt %, or up to, equal to, or at least about 20 wt %, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 20 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or about 90 wt %, based on the total weight of the composition or at least one of the first part or second part of the two-part composition.

In some embodiments, the vinyl-substituted polysiloxane in the composition and at least one of the first part or the second part of the two-part composition comprises first divalent units independently represented by formula X:

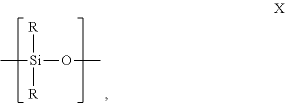

wherein each R is independently —H, —OH, or a substituted or unsubstituted C₁₋₂₀ hydrocarbyl group. In some embodiments, each R is independently a substituted or unsubstituted C₁₋₂₀ hydrocarbyl group. Suitable hydrocarbyl groups include alkyl, alkenyl, alkynyl, cycloalkyl, alkoxy, aryl, arylalkylenyl, or heterocycloalkylenyl, wherein alkyl and arylalkylenyl are unsubstituted or substituted with halogen and optionally interrupted by at least one catenated —O—, —S—, —N(R′)-, or combination thereof (in some embodiments, —O—, —S—, and combinations thereof, or —O—), wherein aryl, arylalkylenyl, and heterocycloalkyenyl are unsubstituted or substituted by at least one alkyl, alkoxy, halogen, or combination thereof. R′ is hydrogen, alkyl, aryl, or arylalkylenyl, wherein aryl and arylalkylenyl are unsubstituted or substituted by at least one alkyl, alkoxy, or combination thereof. In some embodiments, R′ is hydrogen or alkyl, for example, having 1 to 4 carbon atoms (e.g., methyl, ethyl, n-propyl, isopropyl, n-butyl, isobutyl, or sec-butyl). In some embodiments, R′ is methyl or hydrogen. In some embodiments, the halogen or halogens on the alkyl, aryl, arylalkylenyl, or heterocycloalkylenyl groups is fluoro. When R is fluorinated, fluorinated and perfluorinated groups such as F[CF(CF₃)CF₂O]ₐCF(CF₃)CⱼH2ⱼ-(wherein j is an integer of 2 to 8 (or 2 to 3) and a has an average value of 4 to 20), C₄F₉C₃H₆-, C₄F₉C₂H₄-, C₄F₉OC₃H₆-, C₆F₁₃C₃H₆-, CF₃C₃H₆-, and CF₃C₂H₄- can be useful. In some embodiments, the alkyl group is perfluorinated. In some embodiments, each R is independently alkyl, aryl, or alkyl substituted by fluoro and optionally interrupted by at least one catenated —O-group. Suitable alkyl groups for R in formula X typically have 1 to 10, 1 to 6, or 1 to 4 carbon atoms. Examples of useful alkyl groups include methyl, ethyl, isopropyl, n-propyl, n-butyl, and iso-butyl. In some embodiments, each R is independently alkyl having up to six (in some embodiments, up to 4, 3, or 2) carbon atoms, phenyl, benzyl, or C₆H₅C₂H₄-. In some embodiments, each R is independently methyl or phenyl. In some embodiments, each R is methyl.

In some embodiments, the vinyl-substituted polysiloxane in the composition and at least one of the first part or the second part of the two-part composition comprises at least one of a terminal unit represented by formula —Q—CH═CH₂ or a second divalent unit represented by formula XI

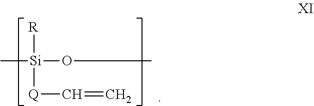

In some embodiments, the vinyl-substituted polysiloxane includes the divalent units represented by formula XI. In formula XI, each R is as defined above for a divalent unit of formula X, and each Q is independently a bond, alkylene, arylene, or alkylene that is at least one of interrupted or terminated by aryl, wherein the alkylene, arylene, and alkylene that is at least one of interrupted or terminated by aryl are optionally at least one of interrupted or terminated by at least one ether (i.e., —O—), thioether (i.e., —S—), amine (i.e., —NR′—), amide (i.e., —N(R′)—C(O)- or 'C(O)—N(R′)—), ester (i.e., —O—C(O)- or —C(O)—O—), thioester (i.e., —S—C(O)- or —C(O)—S—), carbonate (i.e., —O—C(O)—O—), thiocarbonate (i.e., —S—C(O)—O-or —O—C(O)—S—), carbamate (i.e., —(R′)N—C(O)—O- or —O—C(O)—N(R′)-, thiocarbamate (i.e.,—N(R′)—C(O)—S- or —S—C(O)'N(R′)-, urea (i.e., —(R′)N—C(O)—N(R′)—), thiourea (i.e., —(R′)N—C(S)—N(R′)). In any of these groups that include an R′, R′ is hydrogen, alkyl, aryl, or arylalkylenyl, wherein aryl and arylalkylenyl are unsubstiuted or substituted by at least one alkyl, alkoxy, or combination thereof. In some embodiments, R′ is hydrogen or alkyl, for example, having 1 to 4 carbon atoms (e.g., methyl, ethyl, n-propyl, isopropyl, n-butyl, isobutyl, or sec-butyl). In some embodiments, R′ is methyl or hydrogen. The phrase “interrupted by at least one functional group” refers to having part of the alkylene, arylalkylene, or alkylarylene group on either side of the functional group.

An example of an alkylene interrupted by an ether is —CH₂—CH₂—O—CH₂—H₂—. Similarly, an alkylene that is interrupted by arylene has part of the alkylene on either side of the arylene (e.g., —CH₂—CH₂—C₆H₄—CH₂—).

In some embodiments, each Q is independently alkylene that is optionally at least one of interrupted or terminated by at least one ether, thioether, or combination thereof. The alkylene can have 1 to 10, 1 to 6, or 1 to 4 carbon atoms. In some embodiments, Q is alkylene having 1 to 10, 1 to 6, or 1 to 4 carbon atoms. In some embodiments, Q is a poly(alkylene oxide) group. Suitable poly(alkylene oxide) groups include those represented by formula (OR″)_{a′}, in which each OR″ is independently —CH₂CH₂O—, —CH(CH₃)CH₂O—, —CH₂CH₂CH₂O—, —CH₂CH(CH₃)O—, —CH₂CH₂CH₂CH₂O—, —CH(CH₂CH₃)CH₂O—, —CH₂CH(CH₂CH₃)O—, and —CH₂C(CH₃)₂O—. In some embodiments, each OR″ independently represents —CH₂CH₂O—, —CH(CH₃)CH₂O— or —CH₂CH(CH₃)O—. Each a′ is independently a value from 5 to 300 (in some embodiments, from 10 to about 250, or from 20 to about 200). In some embodiments, Q is a bond.

In some embodiments, the vinyl-substituted polysiloxane in the composition and two-part composition comprises a terminal unit represented by formula —Q—CH═CH₂. In some embodiments, the vinyl-substituted polysiloxane includes one terminal unit represented by formula —Q—CH═CH₂. In some embodiments, the vinyl-substituted polysiloxane includes two terminal units represented by formula —Q—CH═CH₂. If the vinyl-substituted polysiloxane is branched, it can include more than two terminal units represented by formula —Q—CH═CH₂. In formula —Q—CH═CH₂, each Q is as defined above in any of the definitions described for formula XI. In some embodiments, Q is a bond.

The vinyl-substituted polysiloxanes can be prepared by known synthetic methods, and many are commercially available (for example, from Wacker Chemie AG, Munich, Germany, Shin-Etsu Chemical, Tokyo, Japan, AB Specialty Silicones, Waukegan, Ill., Dow Corning Corporation, Midland, Mich., or from Gelest, Inc., Morrisville, Pa., (see, for example, the polysiloxanes described in Silicon Compounds: Silanes and Silicones, Second Edition, edited by B. Arkles and G. Larson, Gelest, Inc. (2008)). Fluorinated polysiloxanes can be prepared by using known synthetic methods including the platinum-catalyzed addition reaction of a fluorinated olefin and a hydrosiloxane (small molecule, oligomer, or polymer).

In some embodiments, the vinyl-substituted polysiloxane comprises a vinyl-substituted polysiloxane represented by Formula I:

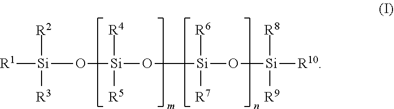

In Formula I, R¹, R², R³, R⁴, R⁵, R⁵, R⁶, R⁷, R⁸, R⁹, and R¹⁰, are independently —H, —OH, or substituted or unsubstituted (C₁-C₂₀)hydrocarbyl as described above for R in any of its embodiments. At least two of R¹, R⁴, R⁵, or R¹⁰ comprises a vinyl group. Additionally, m and n are in random or block orientation. In some embodiments, R¹, R², R³, R⁴, R⁵, R⁶, R⁷, R⁸, R⁹, and R¹⁰ of the polysiloxane according to Formula I are independently substituted or unsubstituted (C₁-C₂₀)alkyl, (C₁-C₂₀)alkenyl, (C₁-C₂₀)alkynyl, (C₁-C₂₀)cycloalkyl,)(C₁-C₂₀ aryl, (C₁-C₂₀)alkoxyl, or (C₁-C₂₀)haloalkyl, wherein at least one of R¹, R⁴, R⁵, or R¹⁰ (comprises a vinyl group. In some embodiments, R¹, R², R³, R⁴, R⁵, R⁶, R⁷, R⁸, R 9 , and R¹⁰ of the polysiloxane according to Formula I are independently substituted or unsubstituted (C₁-C₂₀)alkyl, (C₁-C₂₀)cycloalkyl, (C₁-C₂₀)aryl, or (C₁-C₂₀)haloalkyl, wherein at least one of R¹, R⁴, R⁵, or R¹⁰ comprises a vinyl group.

In Formula I, the units m and n can represent the number of each repeating unit in the polysiloxane. Alternatively or additionally, the units m and n can represent the mol % of each repeating unit in the polysiloxane. The unit n can be any positive integer and the unit m can be any positive integer or zero. In some embodiments, and m+n is in a range from 10 to 500, 10 to 400, 10 to 300, 12 to 300, 13 to 300, 13 to 200, 10 to 100, 10 to 50, or 10 to 30. In some embodiments, n is 0, and m is in a range from 20 to 200, 30 to 100, or 10 to 100. In some embodiments, m is 0, and n is in a range from 20 to 200, 30 to 100, or 10 to 100. In some embodiments when m is 0, at least one of R¹ or R¹⁰ comprises a vinyl group. In some embodiments of Formula I, at least 40 percent, and in some embodiments at least 50 percent, of the R¹, R², R³, R⁴, R⁵, R⁶, R⁷, R⁸, R⁹, and R¹⁰ groups are phenyl, methyl, or combinations thereof. For example, at least 60 percent, at least 70 percent, at least 80 percent, at least 90 percent, at least 95 percent, at least 98 percent, or at least 99 percent of the R¹, R², R³, R⁴, R⁵, R⁶, R⁷, R⁸, R⁹, and R¹⁰ groups can be phenyl, methyl, or combinations thereof. In some embodiments of Formula I, at least 40 percent, and in some embodiments at least 50 percent, of the R¹, R², R³, R⁴, R⁵, R⁶, R⁷, R⁸, R⁹, and R¹⁰ groups are methyl. For example, at least 60 percent, at least 70 percent, at least 80 percent, at least 90 percent, at least 95 percent, at least 98 percent, or at least 99 percent of the R¹, R², R³, R⁴, R⁵, R⁶, R⁷, R⁸, R⁹, and R¹⁰ groups can be methyl. In some embodiments, each R¹, R², R³, R⁴, R⁵, R⁶, R⁷, R⁸, R⁹, and R¹⁰ is methyl. Although Formula I is shown as a block copolymer, it should be understood that the divalent units of formulas X and XI can be randomly positioned in the copolymer. Thus, polyorganosiloxanes useful for practicing the present disclosure also include random copolymers.

In some embodiments, the vinyl-substituted polysiloxane comprises a vinyl-substituted polysiloxane represented by at least one of Formula II or Formula III:

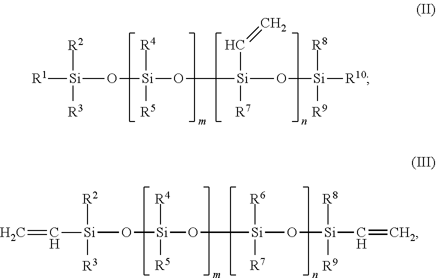

wherein R¹, R², R³, R⁴, R⁵, R⁶, R⁷, R⁸, R⁹, R¹⁰, m and n are as defined above in any of their embodiments.

In some embodiments, the vinyl-substituted polysiloxane comprises a vinyl-substituted polysiloxane represented by Formula IV:

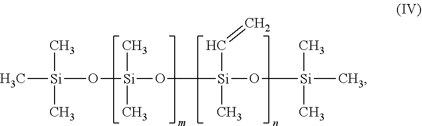

wherein m and n are as defined above in any of their embodiments.

In some embodiments, the vinyl-substituted polysiloxane comprises a vinyl-substituted polysiloxane represented by Formula V:

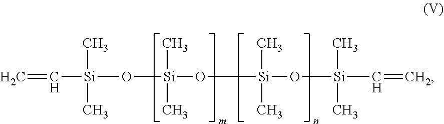

wherein m and n are as defined above in any of their embodiments.

A vinyl content of the one of more vinyl-subsituted polysiloxanes can be in a range of from about 0.0010 mmol/g to about 5 mmol/g, about 0.005 mmol/g to about 0.1 mmol/g, or up to, equal to, or at least about 0.0010 mmol/g, 0.0020, 0.0030, 0.0040, 0.0050, 0.0060, 0.0070, 0.0080, 0.0090, 0.0100, 0.0200, 0.0300, 0.0400, 0.0500, 0.0600, 0.0700, 0.0800, 0.0900, 0.1000, 0.2000, 0.3000, 0.4000, 0.5000, 0.6000, 0.7000, 0.8000, 0.9000, 1, 1.5, 2, 2.5, 3, 3.5, 4, 4.5, or about 5 mmol/g, as reported by the manufacturer.

A viscosity of the one or more vinyl-substituted polysiloxanes can independently be in a range of from about 100 mPa·s to about 500,000 mPa·s at 25° C., about 200 mPa·s to about 300,000 mPa-s, or less than, equal to, or greater than about 100 mPa·s, 150 mPa·s, 200 mPa·s, 250 mPa·s, 300 mPa·s, 350 mPa·s, 400 mPa·s, 450 mPa·s, 500 mPa·s, 250,000 mPa·s, 300,000mPa·s, 400,000mPa·s, 500,000mPa·s at 25° C. As discussed below, the viscosity of the vinyl polysiloxane can affect the uniformity of the closed or open foamed cells formed in some embodiments of a resulting cured composition.

The composition and the second part of the two-part composition of the present disclosure include a hydrosilyl-substituted polysiloxane having at least two silicon-hydride groups. The composition and the second part can include one or more hydrosilyl-substituted polysiloxanes. In some embodiments, the hydrosilyl-substituted polysiloxane is a blend of hydrosilyl-substituted polysiloxanes that differ in structure, molecular weight, mole percent of repeating units, or hydrogen content. In some embodiments, the hydrosilyl-substituted polysiloxane comprises one or more hydrosilyl-substituted polysiloxane homopolymers, hydrosilyl-substituted polysiloxane copolymers, or combinations thereof. The hydrosilyl-substituted polysiloxane forms part of a cross-linked network in a cured product prepared by reaction of the vinyl-substituted polysiloxane and the hydrosilyl-substituted polysiloxane and can also react with any —OH groups to form hydrogen gas which can foam the cured product. The hydrosilyl-subsituted polysiloxane component can be in a range of from about 0.5 wt % to about 30 wt % of the composition or second part of the two-part composition, about 5 wt % to about 30 wt %, or up to, equal to, or at least about 0.5 wt %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or about 30 wt %, based on the total weight of the composition or the second part of the two-part composition.

In some embodiments, the hydrosilyl-substituted polysiloxane in the composition and two-part composition comprises first divalent units independently represented by formula X as defined above in any of its embodiments. In some embodiments, the hydrosilyl-substituted polysiloxane includes at least one of a terminal hydrogen bonded to silicon or a divalent unit represented by formula XII:

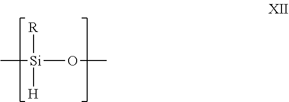

wherein each R is independently as described above in any of its embodiments in connection with formula X and XI.

The hydrosilyl-substituted polysiloxanes can be prepared by known synthetic methods, and many are commercially available (for example, from Dow Corning Corporation or from Gelest, Inc. (see, for example, the polysiloxanes described in Silicon Compounds: Silanes and Silicones, Second Edition, edited by B. Arkles and G. Larson, Gelest, Inc. (2008)).

In some embodiments, the hydrosilyl-substituted polysiloxane comprises a hydrosilyl-substituted polysiloxane represented by formula VI:

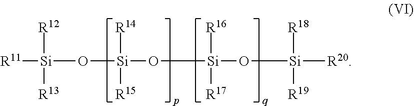

In Formula VI, R¹¹, R¹², R¹³, R¹⁴, R¹⁵, R¹⁶, R¹⁷, R¹⁸, R¹⁹, and R²⁰ are independently —H, —OH, or substituted or unsubstituted (C₁-C₂₀)hydrocarbyl in any of the embodiments described above for R, and at least two of R¹¹, R¹⁴, R¹⁵, and R²⁰ is —H. In ome embodiments R¹¹, R¹², R¹³, R¹⁴, R¹⁵, R¹⁶, R¹⁷, R¹⁸, R¹⁹, R²⁰ of the polysiloxane according to Formula VI are independently —H, —OH, or substituted or unsubstituted (C₁-C₂₀)alkyl, (C₁-C₂₀)alkenyl, (C₁-C₂₀)alkynyl, (C₁-C₂₀)cycloalkyl,)(C₁-C₂₀)aryl, (C₁-C₂₀)alkoxyl, and C₁-C₂₀)haloalkyl, and at least one of. In some embodiments, R¹¹, R¹², R¹³, R¹⁴, R¹⁵, R¹⁶, R¹⁷, R¹⁸, R¹⁹, and R²⁰ of the polysiloxane according to Formula VI are independently substituted or unsubstituted (C₁-C₂₀)alkyl, (C₁-C₂₀)cycloalkyl, (C₁-C₂₀/aryl, or (C₁-C₂₀)haloalkyl, wherein at least one of R¹¹, R¹⁴, R¹⁵, or R²⁰, is —H.

In Formula VI, p and q are in random or block orientation. The units p and q represent the number of each repeating unit in the polysiloxane. Alternatively or additionally, the units p and q represent the mol % of each repeating unit in the polysiloxane. The unit p can be any positive integer and the unit q can be any positive integer or zero. In some embodiments, q is in a range from 0 to 1000 (in some embodiments, 0 to 500, 0 to 400, 0 to 300, 0 to 200, 0 to 150, 0 to 100, or 0 to 20), and p is in a range from 1 to 1000 (in some embodiments, 1 to 500, 1 to 400, 1 to 300, 1 to 200, 1 to 150, 5 to 100, or 20 to 80). In some embodiments, q is 0. In some embodiments, p is in a range from 20 to 80, 30 to 60, or 30 to 50. In some embodiments of formula VI, at least 40 percent, and in some embodiments at least 50 percent, of the R¹¹, R¹², R¹³, R¹⁴, R¹⁵, R¹⁶, R¹⁷, R¹⁸, R¹⁹, and R²⁰ groups are phenyl, methyl, or combinations thereof. For example, at least 60 percent, at least 70 percent, at least 80 percent, at least 90 percent, at least 95 percent, at least 98 percent, or at least 99 percent of the R¹¹, R¹², R¹³, R¹⁴, R¹⁵, R¹⁶, R¹⁷, R¹⁸, R¹⁹, and R²⁰ groups can be phenyl, methyl, or combinations thereof. In some embodiments, at least 40 percent, and in some embodiments at least 50 percent, of the R¹¹, R¹², R¹³, R¹⁴, R¹⁵, R¹⁶, R¹⁷, R¹⁸, R¹⁹, and R²⁰ groups are methyl. For example, at least 60 percent, at least 70 percent, at least 80 percent, at least 90 percent, at least 95 percent, at least 98 percent, or at least 99 percent of the R¹¹, R¹², R¹³, R¹⁴, R¹⁵, R¹⁶, R¹⁷, R¹⁸, R¹⁹, and R²⁰ groups can be methyl. In some embodiments, each of the R¹¹, R¹², R¹³, R¹⁴, R¹⁵, R¹⁶, R¹⁷, R¹⁸, R¹⁹, and R²⁰ is methyl. Although formula VI is shown as a block copolymer, it should be understood that the units can be randomly positioned in the copolymer. Thus, polyorganosiloxanes useful for practicing the present disclosure also include random copolymers.

In some embodiments, the hydrosilyl-substituted polysiloxane comprises at least one of a hydrosilyl-substituted polysiloxane represented by Formula VII or a hydrosilyl-substituted polysiloxane represented by Formula VIII:

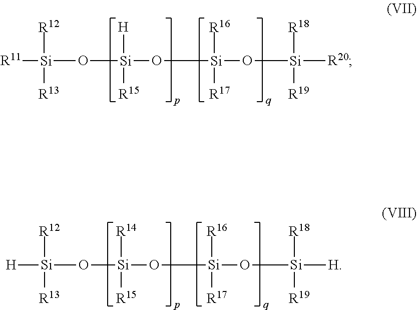

wherein R¹¹, R¹², R¹³, R¹⁴, R¹⁵, R¹⁶, R¹⁷, R¹⁸, R¹⁹, R²⁰, p, and q are as defined above in any of their embodiments.

In some embodiments, the hydrosilyl-substituted polysiloxane comprises a hydrosilyl-substituted polysiloxane represented by Formula IX:

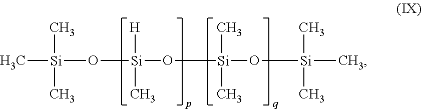

wherein p and q are as defined above in any of their embodiments.

In some embodiments, the hydrosilyl-substituted polysiloxane comprises a hydrosilyl-substituted polysiloxane represented by Formula XX:

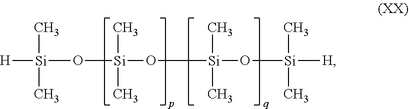

wherein p and q are as defined above in any of their embodiments.

A hydrogen content of the one of more hydrosilyl-substituted polysiloxanes can be in a range of from about 0.0010 mmol/g to about 5 mmol/g, about 0.005mmol/g to about 0.1 mmol/g, or up to, equal to, or at least about 0.0010 mmol/g, 0.0020, 0.0030, 0.0040, 0.0050, 0.0060, 0.0070, 0.0080, 0.0090, 0.0100, 0.0200, 0.0300, 0.0400, 0.0500, 0.0600, 0.0700, 0.0800, 0.0900, 0.1000, 0.2000, 0.3000, 0.4000, 0.5000, 0.6000, 0.7000, 0.8000, 0.9000, 1, 1.5, 2, 2.5, 3, 3.5, 4, 4.5, or about 5 mmol/g. A hydrosilyl equivalency, reported as the mole fraction of DH units (e.g., CH₃(H)SiO) over the mole fraction of the DH units combined with D units (e.g., (CH₃)₂SiO) can be determined using ²⁹Si NMR. In some embodiments, each hydrosilyl-substituted polysiloxane has a hydrosilyl equivalency, reported as the mole fraction of DH units, of at least 20 mol-% DH. In some embodiments, each hydrosilyl-substituted polysiloxane has a hydrosilyl equivalency, reported as the mole fraction of DH units, of up to 100 mol-% DH, calculated using this method.

The polysiloxanes described herein can terminate in any suitable way. In some embodiments, the polysiloxanes can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

The composition of the present disclosure and the first part of the two-part composition of the present disclosure include a hydrosilylation catatlyst. The hydrosilylation catalyst can function to catalyze the formation of a network during curing. The catalyst can be any of those known to catalyze the addition of silicon-bonded hydrogen atoms (hydride groups) to silicon-bonded vinyl radicals (that is, hydrosilylation catalysts). In some embodiments, the hydrosilylation catatlyst includes a transition metal catalyst. The transition metal catalyst is typically a platinum group metal catalyst: ruthenium, rhodium, palladium, osmium, iridium, and platinum. Platinum group metal-containing catalysts can be any of those that are compatible with polysiloxanes. Examples of suitable platinum group metal containing catalysts include platinic chloride, salts of platinum, chloroplatinic acid, and various complexes. In examples where the hydrosilylation catalyst includes a platinum complex, the catalyst can be added in an amount to provide from about 1 ppm to about 1000 ppm platinum to the composition or the first part, in some embodiments, to provide about 10 ppm to about 250 ppm, or up to, equal to, or at least about 1 ppm, 10, 15, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650 ,660, 670, 680, 690, 700, 710, 720, 730, 740, 750, 760, 770, 780, 790, 800, 810, 820, 830, 840, 850, 860, 870, 880, 890, 900, 910, 920, 930, 940, 950 ,960, 970, 980, 990, or about 1000 ppm platinum to the composition or the first part of the two-part composition. In some embodiments, the hydrosilylation catalyst is chloroplatinic acid, complexed with a siloxane such as tetramethylvinylcyclosiloxane (i.e. 1,3,5,7-tetramethyl-1,3,5,7-tetravinylcyclosiloxane) or 1,3-divinyl-1,1,3,3-tetramethyldisiloxane, bis(acetylacetonato)platinum(ii), cis-diamminedichloroplatinum(ii), di-μ-chloro-bis[chloro(cyclohexene)platinum(ii)], bis-dichlorobis(triphenylphosphane)platinum(ii), dichloro(cycloocta-1.5-diene)platinum(ii), dihydrogen hexachloroplatinate(iv) hydrate, dihydrogen hexachloroplatinate(iv), platinum(0) divinyltetramethylsiloxane complex, tetrakis(triphenylphosphane)platinum(0), dihydrogen hexachloroplatinate(iv) solution, or a combination thereof. In some embodiments, the hydrosilylation catalyst is a platinum(0)-1,3-divinyl-1,1,3,3-tetramethyldisiloxane complex (i.e., Karstedt's catalyst).

In some embodiments, the composition of the present disclosure and at least one of the first part or the second part of the two-part composition of the present disclosure comprises at least one of hollow polymeric microspheres or hollow ceramic microspheres. In some embodiments, the composition and at least one of the first or second part can include a blend of microspheres that differ in microsphere composition. For example, the composition and the first and second part can include a blend of hollow polymeric microspheres and hollow ceramic microspheres. The hollow polymeric microspheres and/or hollow ceramic microspheres are useful, for example, for reducing the density of the composition and, in some embodiments, helping a foaming process.

Polymeric microspheres can include a gaseous interior (e.g., air, or any suitable gas, such as an inert gas like nitrogen or argon). Polymeric microspheres can include a polymer shell, which can be formed from any one or more suitable polymers, such as acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a fluoropolymer, a polytetrafluoroethylene polymer (PTFE), a polyethylene terephthalate polymer (PET), a polycyclohexylene dimethylene terephthalate polymer (PCT), a poly(cyclohexylenedimethylene terephthalate-co-ethylene glycol) (PCTG), a TritanTM copolyester, a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), and a combination thereof. The polymer shell can include a polymer formed from one or more independently selected substituted or unsubstituted ethylenically-unsaturated (C₁-C₅₀)hydrocarbons. For example, the polymer shell can include poly(acrylonitrile-co-vinylidene chloride-co-methyl methacrylate).

Suitable polymeric microspheres include pre-expanded or unexpanded microspheres. Unexpanded organic hollow microsphere fillers are available, for example, from Akzo Nobel under the trade designation EXPANCEL. The EXPANCEL microspheres include a polymer shell encapsulating an essentially liquid gas such as liquid isobutane. The unexpanded microspheres expand when the temperature is raised, for example, during curing so that the curable composition expands and foams during curing. EXPANCEL unexpanded microspheres are available in different types characterized, for example, by different onset temperatures. The onset temperature, which can be selected depending on, for example, the curing temperature of the curable composition, can be in a range of from about 80° C. to 130° C.

Unexpanded microspheres are sometimes also referred to as expandable organic microballoons which are also available, for example, from Lehmann & Voss, Hamburg, Germany under the trade designation MICROPEARL.

Pre-expanded polymeric microspheres are commercially available, for example, from Chase Corporation of Westwood, Mass., under the trade designation DUALITE. The pre-expanded polymeric microspheres may include a polymer shell comprising, for example, at least one of an acrylonitrile/acrylate copolymer or a vinylidenechloride/acrylonitrile copolymer. The shell encapsulates, for example, one or more essentially gaseous hydrocarbons.

The polymeric microspheres can be at least partially coated with an inorganic filler. Suitable inorganic fillers include calcium carbonate (Ca(CO₃)₂), aluminum trihydroxide (ATH), and magnesium hydroxide (Mg(OH)₂). The inorganic filler at least partially coated on the polymer microspheres can advantageously be a pH-neutral inorganic filler or an inorganic filler that typically has low moisture absorption and limited solubility in the composition, such as ATH filler and magnesium hydroxide. The fire-retardant characteristics of these fillers may also provide a benefit. In some embodiments, the inorganic filler coating on the polymer microspheres comprises at least one of ATH or Mg(OH)₂. In some embodiments, the polymer microsphere can be blend of polymer microspheres having different inorganic filler coatings.

Hollow ceramic microspheres can include hollow spheres and spheroids. Examples of commercially available hollow ceramic microspheres include glass bubbles marketed by 3M Company, Saint Paul, Minnesota, as “3M GLASS BUBBLES” in grades K1, K15, K20, K25, K37, K46, S15, S22, S32, S35, S38, S38HS, S38XHS, S42HS, S42XHS, S60, S60HS, iM30K, iM16K, XLD3000, XLD6000, and G-65, and any of the HGS series of “3M GLASS BUBBLES”; glass bubbles marketed by Potters Industries, Carlstadt, N.J., under the trade designations “Q-CEL HOLLOW SPHERES” (e.g., grades 30, 6014, 6019, 6028, 6036, 6042, 6048, 5019, 5023, and 5028); and hollow glass particles marketed by Silbrico Corp., Hodgkins, IL, under the trade designation “SIL-CELL” (e.g., grades SIL 35/34, SIL-32, SIL-42, and SIL-43. Yet other examples include alumina/silica microspheres having particle sizes in the range of 5 to 300 microns and a specific gravity of 0.7 (“FILLITE”, Pluess-Stauffer International), aluminum silicate microspheres having a specific gravity of from about 0.45 to about 0.7 (“Z-LIGHT”).

Hollow ceramic microspheres may have a variety of densities useful for lowering the density of the composition. The “average true density” of hollow ceramic microspheres is the quotient obtained by dividing the mass of a sample of microspheres by the true volume of that mass of microspheres as measured by a gas pycnometer. The “true volume” is the aggregate total volume of the microspheres, not the bulk volume. The average true density of the hollow ceramic microspheres useful for practicing the present disclosure is generally at least 0.20 grams per cubic centimeter (g/cc), 0.25 g/cc, or 0.30 g/cc. In some embodiments, the hollow glass microspheres useful for practicing the present disclosure have an average true density of up to about 0.65 g/cc. “About 0.65 g/cc” means 0.65 g/cc ±five percent. In some of these embodiments, the average true density of the hollow glass microspheres disclosed herein may be in a range from 0.1 g/cc to 0.65 g/cc, 0.2 g/cc to 0.65 g/cc, 0.1 g/cc to 0.5 g/cc, 0.3 g/cc to 0.65 g/cc, or 0.3 g/cc to 0.48 g/cc.

Hollow ceramic microspheres can have a variety of useful collapse strengths. A useful isostatic pressure at which ten percent by volume of the hollow ceramic microspheres collapses is at least about 1.7 (in some embodiments, at least about 2.0, 3.8, 5.0, 5.5, 17, 20, or 38) Megapascals (MPa). “About 1.7 MPa” means 1.7 MPa±five percent. In some embodiments, an isostatic pressure at which ten percent, or twenty percent, by volume of the hollow ceramic microspheres collapses is up to 250 (in some embodiments, up to 210, 190, or 170) MPa. For the purposes of the present disclosure, the collapse strength of the hollow ceramic microspheres is measured on a dispersion of the microspheres in glycerol using ASTM D3102 -72“Hydrostatic Collapse Strength of Hollow Glass Microspheres”; with the exception that the sample size (in grams) is equal to 10 times the density of the microspheres. Collapse strength can typically be measured with an accuracy of ±about five percent.

A median diameter size (D₅₀) of at least one of the hollow polymeric microspheres or hollow ceramic microspheres can be in a range of from about 1 μm to about 500 μm, about 20 μm to about 250 μm, or up to, equal to, or at least about 1 μm, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or about 500 μm.

The hollow polymeric microspheres and hollow ceramic microspheres can be present in the composition or at least one of the first part or second part of the two-part composition in any suitable amount. In some embodiments, at least one of the hollow polymeric microspheres or hollow ceramic microspheres are present in the composition, the first part, or the second part in a range of from about 0.05 wt % to about 15 wt % of the curable composition, about 0.30 wt % to about 10 wt %, or up to, equal to, or at least about 0.5 wt %, 1, 1.5, 2, 2.5, 3, 3.5, 4, 4.5, 5, 5.5, 6, 6.5, 7, 7.5, 8, 8.5, 9.5, 10, 10.5, 11, 11.5, 12, 12.5, 13, 13.5, 14, 14.5, or about 15 wt %, based on the total weight of the composition, the first part, or the second part.

The incorporation of at least one of hollow polymeric microspheres or hollow ceramic microspheres into the composition of the present disclosure generally lowers the thermal conductivity of the composition. Thermal conductivity of the composition of the present disclosure is determined after curing the composition using the method described in the examples, below. In some embodiments, the thermal conductivity of the cured composition is up to 0.5 Watt per meter x Kelvin (W/mK), less than 0.5 W/mK, up to 0.4 W/mK, up to 0.3 W/mK, up to 0.2 W/mK, up to 0.1 W/mK, or less than 0.1 W/mK. In some embodiments, the thermal conductivity of the cured composition is in a range from 0.01 W/mK to 0.5 W/mK, from 0.05 W/mK to 0.4 10 W/mK, from 0.05 W/mK to 0.3 W/mK, from 0.01 W/mK to 0.2 W/mK, or from 0.05 W/mK to 0.2 W/mK.

The incorporation of at least one of hollow polymeric microspheres or hollow ceramic microspheres into the composition of the present disclosure generally lowers the electrical conductivity of the composition. One measure of electrical conductivity is the dielectric breakdown voltage, which is the minimum voltage at which an insulator becomes electrically conductive. Dielectric breakdown voltage of the composition of the present disclosure is determined after curing the composition using the method described in the examples, below. In some embodiments, the dielectric breakdown voltage of the cured composition is at least 1 kilovolts per millimeter (kV/mm), at least 2 kV/mm, at least 2 kV/mm, at least 4 kV/mm, at least 5 kV/mm, or at least 6 kV/mm. In some embodiments, the dielectric breakdown voltage of the cured composition is in a range from 1 kV/mm to 10 kV/mm, from 2 kV/mm to 9 kV/mm, from 3 kV/mm to 8 kV/mm, from 4 kV/mm to 8 mV/mK, or from 5 kV/mm to 8 kV/mm.

In some embodiments, the composition of the present disclosure and at least one of the first part or the second part of the two-part composition of the present disclosure includes a second flame retardant. In some embodiments, the second flame retardant comprises at least one of aluminum trihydroxide (ATH), magnesium hydroxide (Mg(OH)₂, wollastonite, humite/hydromagnesite blends, or expandable graphite. In some embodiments, the second flame retardant comprises at least one of ATH or expandable graphite. The second flame retardant is typically in the composition or at least one of the first part or the second part of the two-part composition in an amount less than the phosphorous-containing flame retardant encapsulated in a crosslinked, nitrogen-containing polymer. The second flame retardant can be present in the first part in a range of from about 0.05 wt % to about 30 wt %, about 2 wt % to about 20 wt % of the curable composition, about 5 wt % to about 20 wt %, about 2 wt % to about 15 wt % or up to, equal to, or at least about, 0.05 wt %, 0.5, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or about 30.5 wt %, based on the total weight of the composition or at least one of the first part or the second part of the two-part composition. In some embodiments, the composition of the present disclosure and at least one of the first part or the second part of the two-part composition of the present disclosure does not include a second flame retardant and/or does not include expandable graphite.

Expandable graphite can include a plurality of flakes, which can have a mesh size independently in a range of from about 20 to about 350, about 50 to about 200, or up to, equal to, or at least about 20, 30, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, or about 350 as measured by Standard USA Test Sieves conforming to ASTM E-11-09. The graphite flakes can include moisture (e.g., water) that is pre-adsorbed or pre-blended thereon. Graphite flakes that include moisture can help to create substantially uniform sized foamed cells in the cured composition when foam is formed from the hydrogen gas resulting from the reaction of the hydrosilyl-substituted polysiloxane and moisture from graphite and additionally with any water or alcohol added to the composition. Individual graphite flakes can include moisture in a range of from about 0.05 wt % to about 5 wt % or about 0.1 wt % to about 2 wt %, based on the weight of the flake.

In some embodiments, the composition and at least one of the first part or the second part of the two-part composition includes a foaming agent. In some embodiments, the foaming agent comprises at least one of water, an alcohol having at least one hydroxyl group, or a silanol. In some embodiments, the foaming agent can increase the level of foaming in a cured product formed from the composition of the present disclosure by allowing for a reaction between the water, alcohol, and/or silanol and the hydrosilyl-substituted polysiloxane to create hydrogen gas.

In some embodiments, the composition and at least one of the first part or the second part of the two-part composition includes water. The water can be present in a range of from about 0.01 wt % to about 5 wt % of the composition, the first part or the second part, about 0.01wt % to about 1 wt %, or up to, equal to, or at least about 0.01 wt %, 0.05, 0.1, 0.15, 0.2, 0.25, 0.3, 0.35, 0.4, 0.45, 0.5, 0.55, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.65, 4.7, 4.75, 4.8, 4.85, 4.9, 4.95, or about 5 wt %, based on the total weight of the composition, the first part, or the second part. Water can be added to the composition and at least one of the first part or the second part as a liquid, or it can be added with a filler (e.g., mixed with the filler or adsorbed onto the surface) such as graphite flakes or another filler described below.

In some embodiments, the foaming agent includes an alcohol having at least one hydroxyl group. The alcohol can be present in a range of from about 0.01 wt % to about 5 wt % of the composition and at least one of the first part or the second part of the two-part composition, about 0.01wt % to about 1 wt %, or up to, equal to, or at least about 0.01 wt %, 0.05, 0.1, 0.15, 0.2, 0.25, 0.3, 0.35, 0.4, 0.45, 0.5, 0.55, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.65, 4.7, 4.75, 4.8, 4.85, 4.9, 4.95, or about 5 wt %, based on the total weight of the composition, the first part or the second part. The alcohol having at least one hydroxyl group can include any suitable alcohol. For example, the alcohol can include a monofunctional alcohol, a polyfunctional alcohol, or a combination thereof. Examples of suitable alcohols include propanol, glycol, or a combination thereof. The alcohol can be useful, for example, to help create uniform foamed cells in the cured product or serve as a cross-linker for the polysiloxanes.

To control the rate of polymerization of the composition, the composition or at least one of the first part or the second part of the two-part composition can include a reaction retardant or reaction inhibitor. The reaction retardant can be in a range of from about 0.01 wt % to about 5 wt %, about 0.05 wt % to about 2 wt %, or up to, equal to, or at least about 0.01 wt %, 0.05, 0.1, 0.15, 0.2, 0.25, 0.3, 0.35, 0.4, 0.45, 0.5, 0.55, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.65, 4.7, 4.75, 4.8, 4.85, 4.9, 4.95, or about 5 wt %, based on the total weight of the composition or at least one of the first part or the second part of the two part compoition.

The reaction retardant/inhibitor can be chosen from many suitable compounds that are capable of controlling the rate of polymerization. Examples of suitable reaction retardants include 1,3,5,7-tetramethyl-1,3,5,7-tetravinyl-cyclotetrasiloxane, 1,3-divinyl tetramethyl disiloxane, 2-methyl-3-butyn-2-ol, 2-phenyl-3-butyn-2-ol, 3,5-dimethyl-1-hexyn-3-ol, 1-ethynyl-1-cyclohexanol, 1,5-hexadiene, 1,6-heptadiene; 3,5-dimethyl-1-hexen-lyne, 3-ethyl-3-buten-1-yne, 3-phenyl-3-buten-1-yne; 1,3-divinyltetramethyldisiloxane, 1,3,5,7-tetravinyltetramethyl cyclotetrasiloxane, 1,3-divinyl-1,3-diphenyldimethyldisiloxane, methyltris (3methyl-1-butyn-3-oxy) silane, and combinations thereof.

In some embodiments, the composition and at least one of the first part or the second part of the two-part composition includes an inorganic filler. Inorganic filler can be useful, for example, to increase flame retardancy, to add strength (e.g., tensile strength or % elongation at break), to increase viscosity, to reduce manufacturing costs, or to adjust density in a cured product formed from composition. The inorganic filler can be present in the composition or at least one of the first part or the second part of the two-part composition in a range of from about 2 wt % to about 30 wt %, about 5 wt % to about 15 wt %, or up to, equal to, or at least about 2 wt %, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or about 30 wt %, based on the total weight of the composition or at least one of the first part or the second part of the two-part composition.

Suitable inorganic fillers include fibrous and particulate fillers. The inorganic filler can include glass fibers, aluminum silicate (mullite), synthetic calcium silicate, zirconium silicate, fused silica, crystalline silica graphite, natural silica sand, boron powders (e.g., boron-nitride powder or boron-silicate powders, oxides (e.g., TiO₂, aluminum oxide (particulate or fibrous), magnesium oxide, or zinc oxide), calcium sulfate (e.g., as its anhydride, dehydrate, or trihydrate), calcium carbonate (e.g., chalk, limestone, marble, or synthetic precipitated calcium carbonates), talc (e.g., fibrous, modular, needle shaped, or lamellar talc), wollastonite, surface-treated wollastonite, solid ceramic spheres (e.g., solid glass spheres), kaolin (e.g., hard kaolin, soft kaolin, or calcined kaolin), single crystal fibers or “whiskers” (e.g., of silicon carbide, alumina, boron carbide, iron, nickel, or copper), fibers, including continuous and chopped fibers, (e.g., asbestos or carbon fibers) and short inorganic fibers such as those derived from blends including at least one of aluminum silicates, aluminum oxides, magnesium oxides, or calcium sulfate hemihydrate), sulfides (e.g., molybdenum sulfide or zinc sulfide), barium compounds (e.g., barium titanate, barium ferrite, barium sulfate, or heavy spar), metals (e.g., bronze, zinc, copper and nickel metal mesh or metal plate), flaked fillers (e.g., glass flakes, flaked silicon carbide, aluminum diboride, aluminum flakes, or steel flakes), mica, clay, feldspar, flue dust, fillite, quartz, quartzite, perlite, Tripoli, diatomaceous earth, carbon black, and combinations of any of these fillers. The inorganic filler can be surface treated with silanes, siloxanes, or a combination of silanes and siloxanes to improved adhesion and dispersion. In some embodiments, the inorganic filler is a silica filler. In some embodiments, the inorganic filler is fumed silica.

In some embodiments, the composition and at least one of the first part or the second part of the two-part composition includes an organic filler, for example, in any of the amounts described above for inorganic fillers. Suitable organic fillers include wood flour obtained by pulverizing wood, fibrous products (e.g., kenaf, cellulose, cotton, sisal, jute, flax, starch, corn flour, lignin, ramie, rattan, agave, bamboo, hemp, ground nut shells, corn, coconut (coir), or rice grain husks), polytetrafluoroethylene, reinforcing organic fibrous fillers formed from organic polymers capable of forming fibers (e.g., poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, o r poly(vinyl alcohol), and combinations of any one of these fillers.

In some embodiments, the composition of the present disclosure is packaged as a two-part composition. In some embodiments, the first part includes the vinyl-substituted polysiloxane having at least two vinyl groups, the hydrosilylation catalyst, the phosphorous-containing flame retardant encapsulated in a crosslinked, nitrogen-containing polymer, at least one of the hollow polymeric microspheres or the hollow ceramic microspheres, and at least one of the reaction retardant, the second flame retardant, the inorganic filler, the alcohol having at least one hydroxyl group, or water. In some embodiments, the second part includes the vinyl-substituted polysiloxane having at least two vinyl groups, the hydrosilyl-substituted polysiloxane having at least two silicon-hydride groups, at least one of the hollow polymeric microspheres or the hollow ceramic microspheres, and at least one of the phosphorous-containing flame retardant encapsulated in a crosslinked, nitrogen-containing polymer, a second flame retardant, or the inorganic filler.

The first part and the second part can be combined at any suitable volume ratio. For example, the first part and the second part can be combined at a volume ratio in a range of from about 5:100 to about 100:1, about 10:100 to about 50:1, or up to, equal to, or at least about 5:100, 20:100, 30:100, 40:100, 50:100. 60:100, 70:100, 80:100, 90:100, 1:1, 10:1, 20:1, 30:1, 40:1, 50:1, 60:1, 70:1, 80:1, 90:1, or about 100:1.

After the first part and the second part are combined to form the composition, the composition can be spun or mixed at any suitable speed to facilitate adequate mixing. For example, the composition can be spun or mixed at a low speed by hand. Alternatively, the composition can be spun or mixed at a high speed using a machine. For example, the mixture can be spun at a speed of about 1000 rpm to about 3000 rpm, about 1500 rpm to about 2500 rpm, or up to, equal to, or at least about 1000 rpm, 1100, 1200, 1300, 1400, 1500, 1600, 1700, 1800, 1900, 2000, 2100, 2200, 2300, 2400, 2500, 2600, 2700, 2800, 2900, or about 3000 rpm.

The first part and the second part can be located in any suitable system or kit for containing, mixing, and dispensing the first part and the second part. The system can be suited for large-scale industrial applications or small-scale applications. Either system can include first and second chambers for holding the respective first part and second part. The chambers can be sized for any application and formed from plastic, metal, or any other suitable material. A dispenser can be adapted to receive the first part and the second part and dispense a mixture of the first part and the second part on a substrate. The dispenser can function to facilitate mixing of the first part and the second part, or a mixing chamber can be disposed upstream of the dispenser and in fluid communication with the first chamber and the second chamber. The mixing chamber can be adapted to rotate in order to facilitate mixing, or the mixing chamber can include a number of baffles to induce rotation of the first part and the second part.

To facilitate movement of the first part and the second part, the system can include elements such as one or more plunger or one or more pumps. The one or more plungers can be useful for systems that are handheld. In these embodiments, a user can push one or two plungers, between at least a first and a second position, to force the first part and the second part through the system. If there is one plunger, then the first part and the second part can be dispensed at equal volumes or at a predetermined volume ratio.

Pumps can be useful in industrial applications where large volumes or a continuous supply of the first part and the second part are dispensed. These systems can include one or more pumps that are in fluid communication with the first and second chambers. The one or more pumps can be located downstream of the first and second chambers but upstream of the mixing chamber. In embodiments of the system in which there are two pumps in fluid communication with respective first and second chambers, the pumps can be adapted or controlled to pump an equal volume of the first part and the second part or to pump different quantities of each part according to a predetermined volume ratio.

Following mixing, the composition can be dispensed, by hand or through a system, on to a substrate or into an enclosure and cured. Curing can be accomplished at room temperature although the rate of reaction can be controlled by altering the temperature. For example, the rate of reaction can be slowed by lowering the temperature below room temperature, or the rate of reaction can be increased by raising the temperature above room temperature. In some embodiments, the composition can be cured at a temperature in a range of from about 0° C. to about 100° C., about 15° C. to about 40° C., about 15° C. to about 30° C. or up to, equal to, or at least about 0° C., 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41.5, 42, 42.5, 43, 43.5, 44, 44.5, 45, 45.5, 46, 46.5, 47, 47.5, 48, 48.5, 49, 49.5, 50, 50.5, 51.5, 52, 52.5, 53, 53.5, 54, 54.5, 55, 55.5, 56, 56.5, 57, 57.5, 58, 58.5, 59, 59.5, 60, 60.5, 61.5, 62, 62.5, 63, 63.5, 64, 64.5, 65, 65.5, 66, 66.5, 67, 67.5, 68, 68.5, 69, 69.5, 70, 70.5, 71.5, 72, 72.5, 73, 73.5, 74, 74.5, 75, 75.5, 76, 76.5, 77, 77.5, 78, 78.5, 79, 79.5, 80, 80.5, 81.5, 82, 82.5, 83, 83.5, 84, 84.5, 85, 85.5, 86, 86.5, 87, 87.5, 88, 88.5, 89, 89.5, 90, 90.5, 91.5, 92, 92.5, 93, 93.5, 94, 94.5, 95, 95.5, 96, 96.5, 97, 97.5, 98, 98.5, 99, 99.5, or about 100° C. Curing can occur over any suitable amount of time. For example, curing may occur over an amount of time ranging from about 0.5 minutes to about 24 hours, about 0.5 minutes to about 10 hours, or up to, equal to, or at least about 0.5 minutes, 1 minute, 5 minutes, 10 minutes, 15 minutes, 20 minutes, 25 minutes, 30 minutes, 35 minutes, 40 minutes, 45 minutes, 50 minutes, 55 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, or about 24 hours.

The cured product of the composition is formed from curing any of the compositions described herein. In some embodiments, the cured product is a foam including at least one of hollow polymeric microspheres, hollow ceramic microspheres, or open or closed cells. The density of the cured product can be in a range of from about 0.200 g/cm³ to about 0.800 g/cm³, about 0.300 g/cm³ to about 0.700 g/cm³, or up to, equal to, or at least about 0.200 g/cm³, 0.250, 0.300, 0.350, 0.400, 0.450, 0.500, 0.550, 0.600, 0.650, 0.700, 0.750, or about 0.800 g/cm³. A low density in a cured product can result in weight savings and can contribute to the cured product's ability to be flame retardant and waterproof. The water resistant characteristics of cured product can be determined by International Protection Marketing standard IP68.

In some embodiments of open or closed cell foams, the foamed cells have a uniform size (e.g., largest diameter D₁) and are uniformly distributed throughout the cured composition. The presence of the expandable graphite comprising moisture in the curable composition can promote uniformity in the size and distribution of foamed cells. The expandable graphite includes water, which may react with the hydrosilyl-substituted polysiloxane during curing to foam the cured product. The presence of polymeric microspheres, which typically decreases the density of the curable composition, can also contribute to the uniform size and distribution of foamed cells. Another factor that can contribute to the uniformity of foamed cells is the viscosity of the curable composition. The viscosity can depend on, for example, the vinyl-substituted polysiloxane, the microspheres, and the inorganic filler amount and type added into the curable composition. During curing, if the viscosity of the curable composition is too low, the bubbles formed will simply escape, thus preventing formation of foamed cells. However, if the viscosity is too high, the bubbles formed cannot penetrate through the entire volume of the curable composition. This leads to a non-uniform distribution of foamed cells. For further information regarding the uniformity of foamed cells, Int. Pat. Appl. Pub. No. WO 2020/034117 (Chen et al.). The uniformity of foamed cells provides many benefits in the cured product of the curable composition. For example, in some embodiments, the uniformity of foamed cells can help to ensure that each surface of the cured product is substantially smooth.

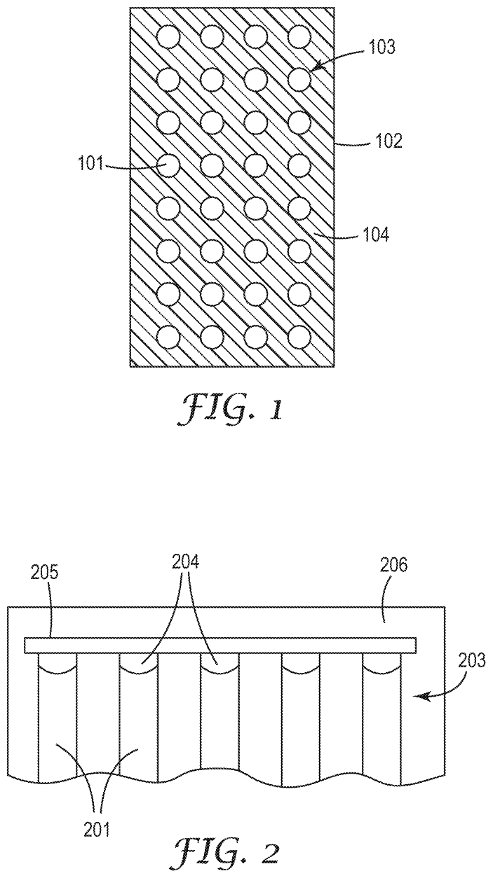

FIG. 1 is a top view of battery cells in a battery module 103 in a battery module casing 102. In the illustrated embodiment, the composition 104 of the present disclosure at least partially encases battery cells within the module 103. In some embodiments, the battery cells 101 are electrically connected to one another. In some embodiments, the battery cells are lithium-ion battery cells. Typically, the composition cures to at least partially encase the battery cells 101 in a cured product of the composition of the present disclosure. The cured product can provide mechanical and thermal protection to the battery cells. The flame-retardant properties of cured product can help to protect a battery cell from external flames or help manage spread of flames from a battery cell to another in the event of a fire caused by a failure.

Battery module 103 can be a component of a vehicle, for example, an all-electric vehicle (EV), a plug-in hybrid vehicle (PHEV), or a hybrid vehicle (HEV). Examples of suitable vehicles include an automobile, a train, an aerospace vehicle (e.g., airplane, helicopter, or space craft), or a water craft.

Suitable examples of battery modules of the present disclosure include lithium-ion batteries, nickel cadmium batteries, and nickel metal hydride batteries.

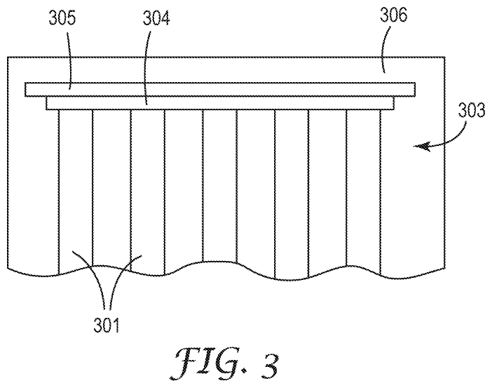

FIG. 2 is a side view of battery cells 201l in a battery module 203 with an embodiment of the composition of the present disclosure at least partially covering battery cells within the module. In the illustrated embodiment, a cured product of the composition of the present disclosure is useful as a pad material 204 on top of the battery cells 201. In some embodiments, the pad material 204 covers a vent area (not shown) of each of the battery cells. In the illustrated embodiment, discrete portions of the cured product of the composition are located on top of the battery cells 201, at least partially covering, for example, the vent area of each battery cells 201 within the module. Also in the illustrated embodiment, a flame barrier sheet 205 covers the pad material 204 that at least partially covers the battery cells 201.

FIG. 3 is a side view of battery cells 301 in a battery module 303 with an embodiment of the composition of the present disclosure at least partially covering battery cells within the module. In the illustrated embodiment, a layer of the composition of the present disclosure as a pad material 304 is located on top of the battery cells 301, at least partially covering battery cells 301 within the module. The layer can cover the vent area of each of the battery cells. Flame barrier sheet 305 covers the layer of the pad material 304 that at least partially covers the battery cells 301.

If an individual battery cell 101, 201, 301 catches on fire, the pad material 204, 304 and flame barrier sheet 205, 305 are ruptured, and gas from the fire can be released into channel 206, 306, which can help decrease spread of flames from one battery cell to another in the battery module. While the cured product of the present disclosure has a high decomposition temperature and typically will absorb a great deal of heat as it decomposes into silicon dioxide and silicon oxide, the flame barrier sheet typically has an ignition temperature much higher than the cured product. The flame barrier sheet is desirably resistant to hot particles that may rain down during a thermal event. The composition and flame barrier sheet together can help to protect a battery cell from external flames or help reduce spread of flames from a battery cell to another in the event of a fire caused by a failure.

In some embodiments, the flame barrier sheet has a thickness of up to 0.40 mm, up to 0.30 mm, or up to 0.20 mm. In some embodiments, the flame barrier sheet has a thickness of at least 0.05 mm, at least 0.075 mm, or at least 0.10 mm. The flame barrier sheet may be selected to have tensile properties that allow it to rupture during a fire as described above in connection with FIGS. 2 and 3. Desirably the flame barrier sheet also provides electrical insulation. In some embodiments, the flame barrier sheet has a dielectric breakdown voltage of at least one, two, three, four, or five kilovolts.

A suitable flame barrier sheet is a flexible 100% m-aramid paper that is commercially available, for example, from DuPont de Nemours, Inc., Wilmington, Del., under the trade designation “NOMEX 410”. In some embodiments, the flame barrier sheet comprises an inorganic paper, and in some embodiments, a ceramic paper. In some embodiments, the flame barrier sheet comprises a flexible mica paper. Useful mica papers can comprise mica and a glass scrim. Some suitable flame barrier sheets are ceramic papers commercially available, for example, from 3M Company, St. Paul, Minn , under the trade designation “3M FLAME BARRIER FRB-NT SERIES”. Other suitable flame barrier sheets are glass fiber and microfiber inorganic insulating papers commercially available, for example, from 3M Company, under the trade designation “3M CEQUIN I, II, 3000 Inorganic Insulating Paper”. Other similar flame barrier sheets may also be useful.

Referring again to FIGS. 2 and 3, the flame barrier sheet 205, 305 can also facilitate assembly of the battery module 203. The composition of the present disclosure can be dispensed on at least one of the plurality of battery cells 201, 301 or on the flame barrier sheet 205, 305 and placing the flame barrier sheet on the plurality of battery cells.

In some embodiments, dispensing the composition comprises dispensing discrete portions as shown in FIG. 2 of the composition on at least one of a vent area of each of the battery cells or on the flame barrier sheet. The composition can be dispensed directly on the battery cells 201, 301 to cover the vent area, or the composition can be first dispensed on the flame barrier sheet in discrete portions that are spaced apart to the same extent as the battery cells. In some embodiments, dispensing the composition comprises dispensing a continuous layer as shown in FIG. 3 of the composition on the plurality of battery cells or on the flame barrier sheet.

Conveniently, the composition of the present disclosure can be dispensed on the flame barrier sheet, and the flame barrier sheet can be placed on the plurality of battery cells. In this way, the composition is placed on the plurality of battery cells using the flame barrier sheet without requiring the use of other tools. The flame barrier sheet 205, 305 can be useful for shaping (e.g., flattening) the composition to make a pad material, for example. In some embodiments, the cured product of the composition becomes adhered to the flame barrier sheet, which can advantageously avoid the use of other adhesives in the module.

### Some Embodiments of the Disclosure

In a first embodiment, the present disclosure provides a composition comprising:
a vinyl-substituted polysiloxane having at least two vinyl groups;
a hydrosilyl-substituted polysiloxane having at least two silicon-hydride groups;
a hydrosilylation catalyst; and
a phosphorous-containing flame retardant encapsulated in a crosslinked, nitrogen-containing polymer.

In a second embodiment, the present disclosure provides the composition of the first embodiment, further comprising at least one of hollow polymeric microspheres or hollow ceramic microspheres.

In a third embodiment, the present disclosure provides the composition of the first or second embodiment, further comprising the hollow polymeric microspheres, and wherein the hollow polymeric microspheres comprise a coating of inorganic filler.

In a fourth embodiment, the present disclosure provides the composition of any one of the first to third embodiments, further comprising a foaming agent.

In a fifth embodiment, the present disclosure provides the composition of the fourth embodiment, wherein the foaming agent comprises at least one of water, an alcohol having at least one hydroxyl group, or a silanol.

In a sixth embodiment, the present disclosure provides the composition of any one of the first to fifth embodiments, further comprising a second flame retardant.

In a seventh embodiment, the present disclosure provides the composition of any one of the first to sixth embodiments, packaged as a two-part composition, wherein the first part comprises the vinyl-substituted polysiloxane having at least two vinyl groups, the hydrosilylation catalyst, and the phosphorous-containing flame retardant encapsulated in the crosslinked, nitrogen-containing polymer, and wherein the second part comprises the hydrosilyl-substituted polysiloxane having at least two silicon-hydride groups and optionally a second vinyl-substituted polysiloxane.

In an eighth embodiment, the present disclosure provides composition comprising:

a first part comprising:
a vinyl-substituted polysiloxane having at least two vinyl groups;
a hydrosilylation catalyst; and
a phosphorous-containing flame retardant encapsulated in a crosslinked, nitrogen-containing polymer, and

a second part comprising:
a second vinyl-substituted polysiloxane; and
a hydrosilyl-substituted polysiloxane having at least two silicon-hydride groups.

In a second embodiment, the present disclosure provides the composition of the first embodiment,

In a ninth embodiment, the present disclosure provides the composition of the eighth embodiment, wherein at least one of the first part or the second part further comprises at least one of hollow polymeric microspheres or hollow ceramic microspheres.

In a tenth embodiment, the present disclosure provides the composition of the eighth or ninth embodiment, wherein at least one of the first part or the second part further comprises the hollow polymeric microspheres, and wherein the hollow polymeric microspheres comprise a coating of inorganic filler.

In an eleventh embodiment, the present disclosure provides the composition of any one of the eighth to tenth embodiments, wherein at least one of the first part or the second part further comprises a foaming agent.

In a twelfth embodiment, the present disclosure provides the composition of the eleventh embodiment, wherein the foaming agent comprises at least one of water, an alcohol having at least one hydroxyl group, or a silanol.

In a thirteenth embodiment, the present disclosure provides the composition of any one of the first to fifth embodiments, wherein at least one of the first part or the second part further comprises a second flame retardant.

In a fourteenth embodiment, the present disclosure provides the composition of any one of the seventh to thirteenth embodiments packaged in a system comprising a first chamber and a second chamber, wherein the first chamber comprises the first part, and wherein the second chamber comprises the second part.

In a fifteenth embodiment, the present disclosure provides the composition fourteenth embodiment, wherein the system further comprises at least one of a dispenser in fluid communication with the first chamber and the second chamber or a mixing tip in fluid communication with the first chamber and the second chamber.

In a sixteenth embodiment, the present disclosure provides the composition of any one of the first to fifteenth embodiments, wherein the hydrosilylation catalyst comprises platinum.

In a seventeenth embodiment, the present disclosure provides the composition of the sixteenth embodiment, wherein the hydrosilylation catalyst provides from about 1 ppm to about 1000 ppm platinum, based on the weight of the first part.

In an eighteenth embodiment, the present disclosure provides the composition of any one of the first 5 to seventeenth embodiments, wherein the vinyl-substituted polysiloxane having at least two vinyl groups comprises a vinyl-substituted polysiloxane represented by Formula I:

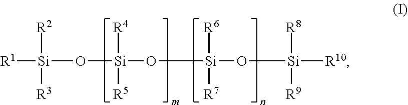

wherein
R¹, R², R³, R⁴, R⁵, R⁶, R⁷, R⁸, R⁹, and R¹⁰ are independently —H, —OH, or substituted or unsubstituted (C₁-C₂₀)hydrocarbyl;
at least two of R¹, R⁴, R⁵, and R¹⁰, comprises a vinyl group;
m is any positive integer;
n is zero or any positive integer; and
m and n are in random or block orientation.

In a nineteenth embodiment, the present disclosure provides the composition of any one of the first to eighteenth embodiments, wherein the vinyl-substituted polysiloxane having at least two vinyl groups comprises a vinyl-substituted polysiloxane represented by Formula II or Formula III:

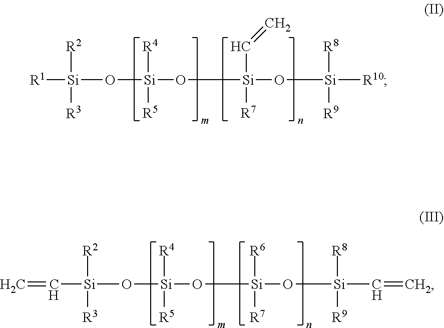

wherein
R¹, R², R³, R⁴, R⁵, R⁶, R⁷, R⁸, R⁹, and R¹⁰ are independently —H, —OH, or substituted or unsubstituted (C₁-C₂₀)alkyl, (C₁-C₂₀)cycloalkyl, (C₁-C₂₀)aryl, or (C₁-C₂₀)haloalkyl;
at least one of R¹, R⁴, R⁵, and R¹⁰, comprises a vinyl group;
n is any positive integer;
m is zero or any positive integer; and
m and n are in random or block orientation.

In a twentieth embodiment, the present disclosure provides the composition of the nineteenth embodiment, wherein each R¹, R², R³, R⁴, R⁵, R⁶, R⁷, R⁸, R⁹, and R¹⁰ is methyl.

In a twenty-first embodiment, the present disclosure provides the composition of any one of the first to twentieth embodiments, wherein the hydrosilyl-substituted polysiloxane comprises a hydrosilyl-substituted polysiloxane represented by Formula VI:

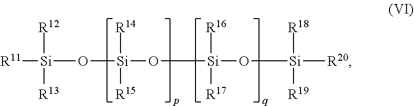

wherein R¹¹, R¹², R¹³, R¹⁴, R¹⁵, R¹⁶, R¹⁷, R¹⁸, R¹⁹, and R²⁰ are independently substituted or unsubstituted (C₁-C₂₀)hydrocarbyl;

at least two of R¹¹, R¹⁴, R¹⁵, and R²⁰, is —H

p is any positive integer;

q is zero or any positive integer; and

p and q are in random or block orientation.

In a twenty-second embodiment, the present disclosure provides the composition of any one of the first to twenty-first embodiments, wherein the hydrosilyl-substituted polysiloxane comprises hydrosilyl-substituted polysiloxane represented by Formula VII or Formula VIII:

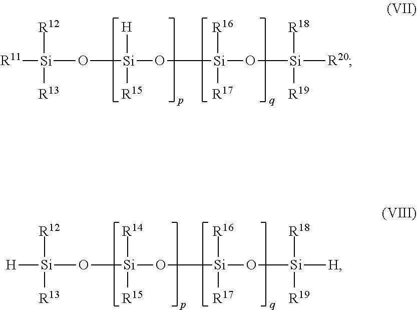

wherein
R¹¹, R¹², R¹³, R¹⁴, R¹⁵, R¹⁶, R¹⁷, R¹⁸, R¹⁹, and R²⁰ are independently substituted or unsubstituted (C₁-C₂₀)alkyl, (C₁-C₂₀)cycloalkyl, (C₁-C₂₀)aryl, or (C₁-C₂₀)haloalkyl;
at least one of R¹¹, R¹⁴, R¹⁵, and R²⁰, is —H;
p is any positive integer;
q is zero or any positive integer; and
p and q are in random or block orientation.

In a twenty-second embodiment, the present disclosure provides the composition of any one of the twenty-first embodiment, wherein each R¹¹, R¹², R¹³, R¹⁴, R¹⁵, R¹⁶, R¹⁷, R¹⁸, R¹⁹, and R²⁰ is methyl.

In a twenty-third embodiment, the present disclosure provides the composition of any one of the first to twenty-second embodiments, further comprising a reaction inhibitor.

In a twenty-fourth embodiment, the present disclosure provides the two-part composition of any one of the first to twenty-third embodiments, further comprising an inorganic filler comprising at least one of a glass, a ceramic, a mineral, or a silica.

In a twenty-fifth embodiment, the present disclosure provides the composition of any one of the first to twenty-fourth embodiments, wherein the phosphorous-containing flame retardant encapsulated in a crosslinked, nitrogen-containing polymer is ammonium polyphosphate encapsulated with melamine resin.

In a twenty-sixth embodiment, the present disclosure provides a battery module comprising:
a plurality of battery cells; and
the composition of any one of the first to twenty-fifth embodiments at least partially encasing the plurality of battery cells.

In a twenty-seventh embodiment, the present disclosure provides the battery module of the twenty-sixth embodiment, wherein the plurality of battery cells are electrically connected to one another.

In a twenty-eighth embodiment, the present disclosure provides a battery module comprising:
a plurality of battery cells that are electrically connected to one another; and
a cured product of the composition of any one of the first to twenty-fifth embodiments at least partially encasing the plurality of battery cells.

In a twenty-ninth embodiment, the present disclosure provides the battery module of any one of the twenty-sixth to twenty-eighth embodiments, further comprising a flame barrier sheet covering at least a portion of the plurality of battery cells.

In a thirtieth embodiment, the present disclosure provides the battery module of the twenty-ninth embodiment, wherein the flame barrier sheet comprises an inorganic paper.

In a thirty-first embodiment, the present disclosure provides the battery module of the thirtieth embodiment, wherein the flame barrier sheet comprises ceramic fibers.

In a thirty-second embodiment, the present disclosure provides a cured product of the composition of any one of the first to twenty-fifth embodiments.

In a thirty-third embodiment, the present disclosure provides the battery module or cured product of any one of the twenty-sixth to thirty-second embodiments, wherein the cured product is substantially flame retardant.

In a thirty-fourth embodiment, the present disclosure provides the battery module or cured product of any one of the twenty-sixth to thirty-third embodiments, wherein the cured product is substantially flame retardant as determined by at least a UL 94 standard, V2, V1 and V0 rating.

In a thirty-fifth embodiment, the present disclosure provides the battery module or cured product of any one of the twenty-sixth to thirty-fourth embodiments, wherein the cured product has a thermal conductivity of not more than 0.5 watts per meter Kelvin.

In a thirty-sixth embodiment, the present disclosure provides the battery module or cured product of any one of the twenty-sixth to thirty-fifth embodiments, wherein the cured product has a dielectric breakdown voltage of at least 1 kilovolt per millimeter.

### EXAMPLES

Various embodiments of the present disclosure can be better understood by reference to the following Examples which are offered by way of illustration. The present disclosure is not limited to the Examples given herein.

TABLE 1
Materials

| Designation | Description | Source |
|---|---|---|
| 2827-186L | Divinyl tetramethyl disiloxane high molecular | AB Specialty Silicones, |
| | weight polymer available under the trade | Waukegan, IL, United |
| | designation ANDISIL 2827-186L | States |
| 920 DET | Low density and moisture absorption polymer | AkzoNobel Industrial |
| | microsphere available under the trade designation | Chemicals, Taixing, |
| | Expancel 920 DET 40 d30 | China |
| ADT 1002 | Expandable graphite available under the designation | Shijiazhuang ADT |
| | ADT 1002 | Carbonic Material |
| | | Factory, China |
| AP 462 | Ammonium polyphosphate, micro-encapsulated | Clariant Corporation, |
| | with melamine resin available under the designation | Charlotte, NC, |
| | Exolit ® AP 462 | United States |
| CE 500 | Silicon-hydride terminated polysiloxane, SiH | AB Specialty Silicones |
| | content 0.16 mmoles/gm, 500 cSt viscosity, | |
| | available under the trade designation ANDISIL CE | |
| | 500 | |
| E065-135D | Low density polymer expanded microspheres | Chase Corporation, |
| | available under the trade designation DUALITE | Westwood, MA, United |
| | E065-135D | States |
| GP-214 | Polyoxyethylene-polyoxypropylene copolymer | Genesee Polymers |
| | available under the designation GP-214 | Corporation, Burton, |
| | | MI. United States |
| H18 | Synthetic, hydrophobic, amorphous silica produced | Wacker Chemie AG, |
| | via flame hydrolysis available under the trade | Munich, Germany |
| | designation HDK ® H18. Pyrogenic Silica. | |
| M9400 SG | A precipitated, surface treated aluminum hydroxide | J.M. Huber Corporation, |
| | (ATH) available under the trade designation | Edison, NJ, United |
| | HYMOD M9400 SG | States |
| MH 20 | Methyl hydrogen polysiloxane polymer available | AB Specialty Silicones |
| | under the trade designation ANDISIL MH 20 | |
| OH 40 | Silanol polymer functional fluid available under the | AB Specialty Silicones |
| | trade designation ANDISIL OH 40 | |
| OP 935 | Fine-grained flame retardant organic phosphinate | Clariant Corporation |
| | available under the designation Exolit ® OP 935 | |
| PG | Propylene glycol | Sinpharm Chemical |
| | | Reagent Co., Ltd, |
| | | Shanghai, China |
| Pt Catalyst | Platinum-divinyltetramethyldisiloxane complex; | Gelest, Morrisville, PA, |
| | 3.0% Pt in vinyl terminated PDMS available under | United States |
| | the designation SIP6830.3 | |
| TS720 | A synthetic, hydrophobic, amorphous silica, | Cabot Corporation, |
| | available under the trade designation CAB-O-SIL | Boston, MA, United |
| | TS-720 | States |
| R8200 | Hydrophobic fumed silica available under the trade | Evonik Corporation, |
| | designation AEROSIL R 8200 | Allentown, PA, United |
| | | States |
| S38 | Soda-lime-borosilicate glass bubbles available | 3M Company, St. Paul, |
| | under the designation Glass Bubbles S38 | MN, United States |
| VS500 | Vinyl-terminated dimethylpolysilxane polymer, 500 | AB Specialty Silicones |
| | cP viscosity, available under the trade designation | |
| | ANDISIL VS 500 | |
| VS1K | Vinyl-terminated dimethylpolysilxane polymer, | AB Specialty Silicones |
| | 1,000 cP viscosity, available under the trade | |
| | designation ANDISIL VS 1,000 | |
| VS2K | Vinyl-terminated dimethylpolysilxane polymer, | AB Specialty Silicones |
| | 2,000 cP viscosity, available under the trade | |
| | designation ANDISIL VS 2,000 | |
| VS80K | Vinyl-terminated dimethylpolysilxane polymer, | AB Specialty Silicones |
| | 80,000 cP viscosity, available under the trade | |
| | designation ANDISIL VS 80,000 | |
| VS165K | Vinyl-terminated dimethylpolysilxane polymer, | AB Specialty Silicones |
| | 165,000 cP viscosity, available under the trade | |
| | designation ANDISIL VS 165,000 | |
| XL-1342 | Silicon-hydride containing polysiloxane, SiH | AB Specialty Silicones |
| | content 8.60 mmoles/gm, 50 cSt viscosity, available | |
| | under the trade designation ANDISIL XL-1342 | |
| XL-17 | Silicon-hydride containing polysiloxane, SiH | AB Specialty Silicones |
| | content 1.95 mmoles/gmt, 50 cSt viscosity, | |
| | available under the trade designation ANDISIL XL-17 | |
| XL-1B | Silicon-hydride containing polysiloxane, SiH | AB Specialty Silicones |
| | content 0.95 mmoles/gm, 100 cSt viscosity, | |
| | available under the trade designation ANDISIL XL-1B | |

### Test Methods

### Flame Test:

UL94 Classification and Flame-Retardant Thermoplastic standard released by the Underwriters Laboratories (USA). If burning stops within 10 seconds on a vertical part (V0), then the test standard considers it a pass. The time it took a sample, while being subjected to the test, to self-extinguish was recorded. Two samples were tested for each example.

### Thermal Conductivity Test:

The method of ISO 22007-2:2015—Determination of thermal conductivity and thermal diffusivity—Part 2: Transient plane heat source (hot disc) were followed.

### Tack Free Time:

Samples were touched with a finger and the amount of time until the mixture did not feel tacky was recorded.

### Specific Gravity:

The method of ASTM D792-13 was followed using a Mettler Toledo balance density kit.

### Dielectric Breakdown Strength Assessment:

For Examples 11 and 12, an 8.5-inch×11-inch (21.6-cm×27.9-cm) piece “3M FRB-NT 102” barrier paper was placed on a large flat surface and secured to the surface using two strips of “3M SPLICING TAPE 4240”. Strips were placed in a parallel fashion and spaced at least 10 cm apart and covered a portion of the 3M FRB material. The tape served as a method to create a defined height. In the space located between the two layers of tape, a quantity of 30 g of material was dispensed to provide coverage across the entire face. A 50-cm blade was then drawn across the top of the two parallel layers of tape to create a continuous 0.11-mm layer of material onto the 3M FRB-NT 102″ barrier paper. Excess material was removed, and the sample was allowed to cure at room temperature for at least 48 hours.

After the 48 hours the two layers of “3M SPLICING TAPE 4240” was removed, and the dielectric strength was measured using a Phenix PAD56 with electrode diameter of 0.254 inch (0.645 cm) in accordance with ASTM D149 at 23° C. and 35% relative humidity using the following method.

A sample at least 5 cm×5 cm was cut from the cured sample. The sample was placed in between the two copper testing electrodes and secured so that electrodes made uniform contact with the sample. A DC voltage was applied between the two terminals, through the thickness of the sample. Voltages were applied for 60 seconds, and the resulting current was recorded. Increasingly greater voltages were applied to the sample, and the resulting current measurements were recorded. Breakdown voltage was determined by the voltage at which an electrical burn-through punctures the sample or decomposition occurs in the specimen.

For Examples 5 and 6, the same procedure was followed except that the material was dispensed on a polyethylene terephthalate (PET) release liner instead of “3M FRB-NT 102” barrier paper. After allowing to cure for at least 24 hours at room temperature, the sample was removed from the PET release liner.

### Peel Time:

After mixing Part A and Part B, the composition was dispensed onto a PET liner. Attempts were made to peel the composition off the liner every three to five minutes. When the composition is not cured, it will leave residue on the liner after it is peeled from the liner. The time elapsed before the composition could be peeled from the liner without leaving residue was reported.

### Comparative Example 1 (CE1) and Examples 1-10 (EX1-EX10)

### Step 1: Part A

Part A components of the formulations represented in Table 2 were mixed with a SPEEDMIXER DAC 400 FVZ high-speed shear mixer from Flack Tek, Inc. of Landrum, SC, United States at 1500-2500 revolutions per minute (RPM) for two to five minutes until the components were thoroughly mixed. Quantities of the materials are represented in grams.

TABLE 2
Part A

| Material | CE1 | EX1 | EX2 | EX3 | EX4 | EX5 | EX6 | EX7 | EX8 | EX9 | EX10 |
|---|---|---|---|---|---|---|---|---|---|---|---|
| VS500 | 38.0 | 0.0 | 0.0 | 0.0 | 0.0 | 0.0 | 29.3 | 30.0 | 30.0 | 40.0 | 38.0 |
| VS1K | 0.0 | 0.0 | 0.0 | 0.0 | 40.0 | 0.0 | 29.3 | 30.0 | 45.0 | 29.5 | 0.0 |
| VS2K | 0.0 | 50.0 | 50.0 | 50.0 | 0.0 | 50.0 | 0.0 | 0.0 | 0.0 | 0.0 | 0.0 |
| OH 40 | 0.0 | 12.8 | 12.8 | 12.8 | 0.0 | 16.0 | 0.0 | 0.0 | 0.0 | 0.0 | 0.0 |
| GP-214 | 0.0 | 0.16 | 0.16 | 0.16 | 0.0 | 2.6 | 0.0 | 0.0 | 0.0 | 0.0 | 0.0 |
| Pt Catalyst | 0.1 | 0.13 | 0.13 | 0.13 | 0.13 | 0.13 | 0.2 | 0.4 | 0.13 | 0.085 | 0.1 |
| TS720 | 0.0 | 0.0 | 0.0 | 0.0 | 0.0 | 4.0 | 1.0 | 1.6 | 0.0 | 0.0 | 0.0 |
| R8200 | 6.0 | 1.6 | 1.6 | 1.6 | 0.0 | 0.0 | 0.0 | 0.0 | 0.0 | 0.0 | 6.0 |
| H18 | 0.0 | 0.0 | 0.0 | 0.0 | 1.6 | 0.0 | 0.0 | 0.0 | 1.6 | 1.04 | 0.0 |
| 9400 SG | 50.0 | 6.0 | 0.0 | 17.0 | 0.0 | 6.0 | 0.0 | 10.0 | 0.0 | 0.0 | 10.0 |
| ADT 1002 | 0.0 | 0.0 | 0.0 | 0.0 | 8.0 | 0.0 | 0.0 | 0.0 | 10.0 | 6.5 | 0.0 |
| AP 462 | 0.0 | 35.0 | 32.0 | 24.0 | 10.0 | 35.0 | 32.6 | 0.0 | 15.0 | 19.5 | 20.0 |
| S38 | 0.0 | 0.0 | 0.0 | 0.0 | 12.5 | 0.0 | 0.0 | 0.0 | 0.0 | 0.0 | 0.0 |
| E065-135D | 0.0 | 0.0 | 0.0 | 0.0 | 0.0 | 0.0 | 6.5 | 7.5 | 12.0 | 0.0 | 0.0 |
| PG | 0.0 | 0.0 | 0.0 | 0.0 | 0.0 | 0.0 | 0.0 | 0.0 | 0.0 | 0.0 | 0.6 |
| 920 DE | 0.0 | 0.0 | 0.0 | 0.0 | 0.0 | 0.0 | 0.0 | 0.0 | 0.0 | 6.5 | 0.0 |
| 2827-186L | 1.0 | 0.0 | 0.0 | 0.0 | 0.0 | 0.0 | 0.0 | 0.0 | 0.0 | 0.0 | 1.0 |

### Step 2: Part B

Part B components of the formulations represented in Table 3 were mixed with a SPEEDMIXER DAC 400 FVZ high-speed shear mixer from Flack Tek, Inc.at 1500-2500 RPM for two to five minutes until all the components were thoroughly mixed. Quantities of the materials are represented in grams.

TABLE 3
Part B

| Material | CE1 | EX1 | EX2 | EX3 | EX4 | EX5 | EX6 | EX7 | EX8 | EX9 | EX10 |
|---|---|---|---|---|---|---|---|---|---|---|---|
| VS165K | 42.0 | 0.0 | 0.0 | 0.0 | 0.0 | 0.0 | 0.0 | 0.0 | 0.0 | 0.0 | 42.0 |
| VS80K | 0.0 | 8.0 | 8.0 | 8.0 | 0.0 | 0.0 | 0.0 | 0.0 | 0.0 | 0.0 | 0.0 |
| VS500 | 0.0 | 0.0 | 0.0 | 0.0 | 0.0 | 0.0 | 9.9 | 40.0 | 35.0 | 40.0 | 0.0 |
| VS1K | 0.0 | 0.0 | 0.0 | 0.0 | 40.0 | 0.0 | 23.1 | 40.0 | 35.0 | 22.5 | 0.0 |
| VS2K | 0.0 | 24.0 | 24.0 | 24.0 | 0.0 | 28.0 | 0.0 | 0.0 | 0.0 | 0.0 | 0.0 |
| MH 20 | 6.0 | 15.0 | 15.0 | 15.0 | 0.0 | 18 | 0.0 | 0.0 | 0.0 | 0.0 | 6.0 |
| X-1342 | 0.0 | 0.0 | 0.0 | 0.0 | 3.0 | 0.0 | 0.0 | 0.0 | 0.0 | 0.0 | 0.0 |
| XL-17 | 0.0 | 0.0 | 0.0 | 0.0 | 0.0 | 0.0 | 0.0 | 0.0 | 11.0 | 7.15 | 0.0 |
| XL-1B | 0.0 | 0.0 | 0.0 | 0.0 | 0.0 | 0.0 | 13.19 | 20.0 | 0.0 | 0.0 | 0.0 |
| CE 500 | 0.0 | 0.0 | 0.0 | 0.0 | 0.0 | 0.0 | 13.19 | 20.0 | 0.0 | 0.0 | 0.0 |
| R8200 | 8.0 | 1.6 | 1.6 | 1.6 | 0.0 | 0.0 | 0.0 | 0.0 | 0.0 | 0.0 | 8.0 |
| TS720 | 0.0 | 0.0 | 0.0 | 0.0 | 0.0 | 4.0 | 1.0 | 1.6 | 0.0 | 0.0 | 0.0 |
| H18 | 0.0 | 0.0 | 0.0 | 0.0 | 1.6 | 0.0 | 0.0 | 0.0 | 1.6 | 1.04 | 0.0 |
| 9400 SG | 0.0 | 15.0 | 0.0 | 26.0 | 0.0 | 15.0 | 0.0 | 0.0 | 0.0 | 0.0 | 0.0 |
| ADT 1002 | 0.0 | 0.0 | 0.0 | 0.0 | 0.0 | 0.0 | 0.0 | 0.0 | 10.0 | 6.5 | 0.0 |
| AP 462 | 0.0 | 40.0 | 46.0 | 29.0 | 14.0 | 40.0 | 33.0 | 100.0 | 15.0 | 19.5 | 20.0 |
| OP 935 | 30.0 | 0.0 | 0.0 | 0.0 | 0.0 | 0.0 | 0.0 | 0.0 | 0.0 | 0.0 | 0.0 |
| S38 | 0.0 | 0.0 | 0.0 | 0.0 | 12.5 | 0.0 | 0.0 | 0.0 | 0.0 | 0.0 | 0.0 |
| E065-135D | 0.0 | 0.0 | 0.0 | 0.0 | 0.0 | 0.0 | 6.6 | 12.5 | 12.0 | 0.0 | 0.0 |
| 920 DE | 0.0 | 0.0 | 0.0 | 0.0 | 0.0 | 0.0 | 0.0 | 0.0 | 0.0 | 6.5 | 0.0 |
| 2827-186L | 1.0 | 1.92 | 1.92 | 1.92 | 0.3 | 1.9 | 0.03 | 0.06 | 0.3 | 0.2 | 0.0 |

### Step 3: Mix Part A and Part B

Parts A and B were filled in to 1:1 dual pack cartridge and mixed at a 1:1 volume with a 2K dispense gun (except EX7) from 3M Company with an 18-element mixing nozzle and left for 24 hours at room temperature. EX7 was mixed using a 1:2 dual pack cartridge and mixed at a 1:2 1:1 volume with a 2K dispense gun with an 18-element mixing nozzle.

Examples 1 to 4 samples were subjected to flame testing, and the results are provided in Table 4.

TABLE 4
Flame Test Results

| Example | Test 1 (seconds) | Test 2 (seconds) |
|---|---|---|
| EX1 | 1.3 | 1.0 |
| EX2 | 2.6 | 1.3 |
| EX3 | 7.8 | 8.3 |
| EX4 | 1.1 | 1.2 |

Examples 5 to 9 were subjected to thermal conductivity testing, and the results are provided in Table 5.

TABLE 5
Thermal Conductivity Test Results

| | Thermal | | Dielectric | |
|---|---|---|---|---|
| | conductivity | Density | Breakdown Voltage | UL94, |
| Example | (W/m · K) | (kg/m³) | (kV/mm) | V0 |
| EX5 | 0.08 | 0.42 | 6.48 | yes |
| EX6 | 0.137 | 0.67 | 7.2 | yes |
| EX7 | 0.145 | 0.65 | ND | yes |
| EX8 | 0.125 | 0.5 | ND | yes |
| EX9 | 0.095 | 0.42 | ND | yes |

ND = not determined

Example 10 and Comparative Example 1 were subjected to peel time testing when freshly prepared and after storage Part A and Part B for 10 days, and the results are provided in Table 6, below.

TABLE 6
Peel Time Test Results

| | CE1 | EX10 |
|---|---|---|
| Peel time from liner at | >60 min, tack free | 24 min, tack free |
| initial | | |
| Peel time from liner at | >60 mins, not tack free | 25 min, tack free |
| 10 days | | |

Example 6 was coated onto “3M FRB-NT 102” barrier paper as described above for the Dielectric Breakdown Strength Assessment. Leakage current measured at 2.7 kV, 3.0 kV, and 3.5 kV for all the evaluations was less than 0.1 microamps. Two controls were run with just “3M FRB-NT 102” barrier paper, and Examples 11 and 12 (EX 11 and 12) were prepared using Example 6. The results are shown in Table 7, below.

TABLE 7
Examples 11 and 12: Dielectric Breakdown Strength Assessment

| | Foam | Electrode | Thickness | Breakdown |
|---|---|---|---|---|
| Sample | Example | Orientation | (mm) | (kV) |
| Control | none | paper+/paper− | 0.104 | 4.2 |
| Control | none | paper+/paper− | 0.097 | 4.5 |
| EX 11 | EX 6 | foam+/paper− | 0.201 | >6 |
| EX 12 | EX 6 | foam+/paper− | 0.166 | >6 |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

1. A composition comprising:
a vinyl-substituted polysiloxane having at least two vinyl groups;
a hydrosilyl-substituted polysiloxane having at least two silicon-hydride groups;
a hydrosilylation catalyst; and
a phosphorous-containing flame retardant encapsulated in a crosslinked, nitrogen-containing polymer.

2. The composition of claim 1, further comprising at least one of hollow polymeric microspheres or hollow ceramic microspheres.

3. The composition of claim 2, wherein the composition comprises the hollow polymeric microspheres, and wherein the hollow polymeric microspheres comprise a coating of inorganic filler.

4. The composition of claim 1, further comprising a foaming agent comprising at least one of water, an alcohol having at least one hydroxyl group, or a silanol.

5. The composition of claim 1, further comprising a second flame retardant.

6. A composition comprising:
a first part comprising:
a vinyl-substituted polysiloxane having at least two vinyl groups;
a hydrosilylation catalyst; and
a phosphorous-containing flame retardant encapsulated in a crosslinked, nitrogen-containing polymer, and
a second part comprising:
a second vinyl-substituted polysiloxane; and
a hydrosilyl-substituted polysiloxane having at least two silicon-hydride groups.

7. The composition of claim 6, wherein at least one of the first part or the second part further comprises at least one of hollow polymeric microspheres, hollow ceramic microspheres, or a foaming agent.

8. The composition of claim 6, wherein at least one of the first part or the second part further comprises hollow polymeric microspheres, and wherein the hollow polymeric microspheres comprise a coating of inorganic filler.

9. The composition of claim 6, wherein at least one of the first part or the second part further comprises a second flame retardant.

10. The composition of claim 6, packaged in a system comprising a first chamber and a second chamber, wherein the first chamber comprises the first part, and wherein the second chamber comprises the second part.

11. The composition of claim 1, wherein the hydrosilylation catalyst comprises platinum.

12. The composition of claim 1, wherein the vinyl-substituted polysiloxane comprises a vinyl-substituted polysiloxane represented by formula: 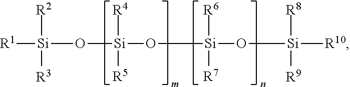
wherein
R¹, R², R³, R⁴, R⁵, R⁶, R⁷, R⁸, R⁹, and R¹⁰ are independently hydrogen, hydroxyl, or substituted or unsubstituted (C₁-C₂₀)hydrocarbyl, wherein at least two of R¹, R⁴, R⁵, or R¹⁰ comprises a vinyl group;
m is any positive integer;
n is zero or any positive integer; and
m and n are in random or block orientation, and
wherein the hydrosilyl-substituted polysiloxane comprises a hydrosilyl-substituted polysiloxane represented by formula: 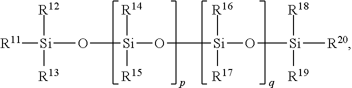
wherein R¹¹, R¹², R¹³, R¹⁴, R¹⁵, R¹⁶, R¹⁷, R¹⁸, R¹⁹, and R²⁰ are independently substituted or unsubstituted (C₁-C₂₀)hydrocarbyl, and at least two of R¹⁴, R¹⁴, R¹⁵, and R²⁰, is —H;
p is any positive integer;
q is zero or any positive integer; and
p and q are in random or block orientation.

13. The composition of claim 1, wherein the phosphorous-containing flame retardant encapsulated in a crosslinked, nitrogen-containing polymer is ammonium polyphosphate encapsulated with melamine resin.

14. A cured product of the composition of claim 1, wherein the cured product has a thermal conductivity of not more than 0.5 watts per meter Kelvin, and/or wherein the cured product has a dielectric breakdown voltage of at least 1 kilovolt per millimeter.

15. A battery module comprising:
a plurality of battery cells electrically connected to one another; and
the composition of claim 1 at least partially encasing the plurality of battery cells.

16. The battery module of claim 15, further comprising a flame barrier sheet at least partially covering the plurality of battery cells.

17. The composition of claim 6, wherein the hydrosilylation catalyst comprises platinum.

18. The composition of claim 6, wherein the vinyl-substituted polysiloxane comprises a vinyl-substituted polysiloxane represented by formula: 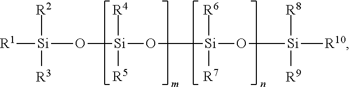
wherein
R¹, R², R³, R⁴, R⁵, R⁶, R⁷, R⁸, R⁹, and R¹⁰ are independently hydrogen, hydroxyl, or substituted or unsubstituted (C₁-C₂₀)hydrocarbyl, wherein at least two of R¹, R⁴, R⁵, or R¹⁰ comprises a vinyl group;
m is any positive integer;
n is zero or any positive integer; and
m and n are in random or block orientation, and
wherein the hydrosilyl-substituted polysiloxane comprises a hydrosilyl-substituted polysiloxane represented by formula: 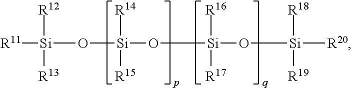
wherein R¹¹, R¹², R¹³, R¹⁴, R¹⁵, R¹⁶, R¹⁷, R¹⁸, R¹⁹, and R²⁰ are independently substituted or unsubstituted (C₁-C₂₀)hydrocarbyl, and at least two of R¹¹, R¹⁴, R¹⁵, and R²⁰, is —H;
p is any positive integer;
q is zero or any positive integer; and
p and q are in random or block orientation.

19. The composition of claim 6, wherein the phosphorous-containing flame retardant encapsulated in a crosslinked, nitrogen-containing polymer is ammonium polyphosphate encapsulated with melamine resin.

20. The composition of claim 6, further comprising a foaming agent comprising at least one of water, an alcohol having at least one hydroxyl group, or a silanol.
